(19) United States
(12) Patent Application Publication
(10) Pub. No.: US 2006/0274695 A1
(43) Pub. Date: Dec. 7, 2006

(54) System and method for effectuating a connection to a network

(75) Inventors: Govindarajan Krishnamurthi, Arlington, MA (US); Tat Keung Chan, San Diego, CA (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation, Espoo (FI)

(21) Appl. No.: 11/145,162

(22) Filed: Jun. 3, 2005

(51) Int. Cl. H04Q 7/00; H04Q 7/24; H04L 9/00

(52) U.S. Cl. 370/331; 370/338; 713/155

(57) ABSTRACT

A system for connecting a mobile node includes a target network, and may include an anchor network. The anchor network can generate token information based upon a trust relationship between the mobile node and the anchor network, and a trust relationship between the target network and the anchor network. The anchor network can then transmit the token information to the mobile node. Thereafter, during connection of the mobile node, the target network is capable of establishing a link-layer connection with the mobile node over a previously established physical-layer connection. The target network is also capable receiving of a handoff attach message including the token information, and thereafter authenticating the mobile node based upon the handoff attach message. And if the mobile node is authenticated, the target network is capable of establishing a network-layer connection with the mobile node over the link-layer connection.

### FIELD OF THE INVENTION

Embodiments of the present invention generally relate to systems and methods of connecting a mobile node to a router in a network and, more particularly, relate to systems and methods of effectuating a network-layer connection to a network, such as during powering up the mobile node or handing off the mobile node from one network to another network.

### BACKGROUND OF THE INVENTION

The mobile Internet Protocol (IP) enables a mobile terminal to move freely from one point of connection to another in various networks it visits along its route. In particular, the MIP protocol describes those actions that enable a mobile terminal to maintain connectivity during a handoff from one access router to another access router. For example, a mobile terminal operating in an enhanced third-generation (3G) wireless communication network such as 1XEV-DO (TIA/EIA/IS-856) may desire to move to a wireless local area network (WLAN), and vice versa. In a more particular example, consider a terminal user engaged in a voice over IP (VoIP) call in a 1XEV-DO network. When the user enters an area, such as the user's office, providing WLAN connectivity, the user may desire to move the VoIP call from the 1XEV-DO network to the WLAN, such as to obtain better or more economical connectivity, speed, quality of service (QoS) and the like.

A typical handoff of the mobile terminal requires link-layer and network-layer (e.g., IP-layer) signaling. When a mobile terminal is handed off from one network to another network, the mobile terminal is typically authenticated and authorized at the link layer as well as the network layer. Then, each instance in which the mobile terminal is handed off, the authentication and authorization procedure must often be repeated for the network into which the mobile terminal is handed off. However, during the movement of the mobile node from one network to another there should be minimal disruption to an application (at the application layer) running on the mobile node. Unfortunately, a disruption may arise due to increased procedure steps, response latency, packet loss, and the like, during such a handoff.

More particularly, for example, one framework providing single sign-on solutions for authenticating and authorizing mobile terminals is defined by the Liberty Alliance Project that is part of the Open Mobile Alliance (OMA). In this regard, the Liberty Alliance Project framework enables a user to access a variety of services (traditionally based within an administrative domain) after a single authentication procedure. In accordance with the Liberty Alliance Project, an identity provider (IdP) maintains the credentials and authorization profiles for a plurality of users. When a registered user desires to access a service of a service provider, the service provider first performs an authentication and authorization procedure to authenticate the user and establish whether the user is authorized to access the service. Thus, in response to a user request to access the service, the service provider typically sends an authentication request back to the user. The user forwards the request to the identity provider.

After authenticating the user and establishing that the user is authorized to access the service, the identity provider forwards an assertion token back to the user. In this regard, the assertion token may include information that is particular to the user along with other protections to prevent misuse of the assertion token. After receiving the assertion token, the user transfers the assertion token to the service provider, which verifies the assertion token and permits the user access to the service (if the assertion token is successfully verified).

This Liberty Alliance Project framework can be applied to the process of authenticating and authorization a mobile terminal when handing off a mobile terminal from one network to another network, in which case the desired service can be considered access to the new, target network. Thus, before the mobile terminal is permitted access to the target network, the target network provider typically performs an authentication and authorization procedure such as that outlined above. In this regard, efficient and effective handoff of the mobile terminal typically requires that such an authentication and authorization procedure be quickly performed to reduce the likelihood of a glitch at the application layer. As described above, however, the typical Liberty Alliance Project framework single sign-on operations involve the generation of an assertion token in response to the service provider requesting authentication and authorization of the user. Thus, frameworks such as that specified by the Liberty Alliance Project undesirably result in a high number of messages across an air interface, which in turn, increase the likelihood of disruption at the application layer during handoff. In addition, frameworks such as that specified by the Liberty Alliance Project framework deal with authentications and authorizations, and typically do not facilitate the establishment of secure communications between the mobile terminal and the service provider, which may be required in a handoff use case.

### SUMMARY OF THE INVENTION

In light of the foregoing background, embodiments of the present invention provide an improved system and method for effectuating network-layer connection to a network, such as to handoff a mobile node from one point of connection to another in various networks the mobile node visits along its route, or to connect the mobile node to a point of connection during powering up or startup of the mobile node. Embodiments of the present invention are capable of effectuating connection of a mobile node to a network, while reducing the message exchange required at the time of handoff or startup connection. More particularly, exemplary embodiments of the present invention are capable of proactively generating a token, such as an assertion token or startup token, which a mobile node may use for authentication at the time of handoff or startup connection. But since the token is generated before effectuating the connection, the message exchange required to generate the respective token need not take place during handoff or startup connection. In addition, exemplary embodiments of the present invention are capable of connecting a terminal to a network with which the terminal does not have a pre-existing trust relationship.

According to one aspect of the present invention, a communication system is provided that includes an anchor network for facilitating handing off a mobile node to a target network. The anchor network includes one or more network entities, such as an identity provider (IdP) and in various instances a home agent (HA), that include one or more processing elements. The processing element(s) are capable of generating token information, such as assertion token information for effectuating handoff of the mobile node, or startup token information for effectuating connection of the mobile node during powering up the mobile node. In this regard, the assertion token information can be generated based upon a trust relationship between the mobile node and the anchor network, and a trust relationship between the target network and the anchor network. In various instances the target network and the anchor network are members of a federation. In such instances, the processing element(s) can be capable of generating the assertion token information based upon a trust relationship between members of the federation, the trust relationship being that between the target and anchor networks.

More particularly, the trust relationship between the mobile node and the anchor network can be evidenced by either a first shared key (e.g., SSₘₙ_{_{—}}_{idp}) or key pairs (i.e., private/public key pairs), while the trust relationship between the target network and the anchor network is evidenced by either a second shared key (e.g., SSₛₚ_{_{—}}_{idp}, SS_{fed}) or key pairs. In this regard, exemplary embodiments of the present invention may be shown and described with respect to symmetric key cryptography using shared, secret keys. It should be understood, however, that such embodiments are equally applicable to asymmetric key cryptography using public/private key pairs, or a combination of symmetric and asymmetric key cryptography. The processing element(s) can accordingly be capable of generating the assertion token information according to a process including selecting a first nonce (a random number that is typically only selected once) (e.g., mn_nonce), and deriving key, mn_key, from the first shared key/key pair and the first nonce. Similarly, the processing element(s) can be capable of selecting a second nonce (e.g., net_nonce), and deriving a key, net_key, from the second shared key/key pair and the second nonce. Thereafter, the processing element(s) can be capable of generating assertion token information comprising an assertion token having a portion encrypted with net_key and, if so desired, an encrypted portion including the second nonce.

Irrespective of how the handoff assertion token information is generated, before generating the assertion token information, the processing element(s) can be capable of authenticating and verifying authorization of the mobile node to access the target network before generating the assertion token information. In such instances, the processing element(s) can be capable of generating the assertion token information when authentication and authorization of the mobile node is verified, and otherwise refusing to generate the assertion token information. After generating the assertion token information, the processing element(s) of the anchor network are capable of transmitting the assertion token information to the mobile node such that the mobile node can thereafter use the assertion token information to authenticate to the target network during handoff of the mobile node from the anchor network to the target network. To provide the assertion token information, the processing element(s) are capable of generating and transmitting the assertion token information before handoff of the mobile node is effectuated, where handoff of the mobile node includes establishing physical-layer, link-layer and network-layer connections with the target network.

The system can also include a target network for receiving a mobile node, such as during handoff of the mobile node from an anchor network or during powering up the mobile node. Like the anchor network, the target network also includes one or more network entities, such as a target foreign agent (FA) and an authentication center (e.g., a Liberty Alliance Project-enabled authentication center—LEAC). The entit(ies) of the target network include one or more processing elements that, to effectuate handoff of the mobile node, are capable of establishing a link-layer connection with the mobile node over a previously established physical-layer connection. The processing element(s) are also capable of receiving a handoff attach message from the mobile node. The handoff attach message includes the assertion token information, and thereafter authenticating the mobile node based upon the handoff attach message. And if the mobile node is authenticated, the processing element(s) are capable of establishing a network-layer connection with the mobile node over the link-layer connection.

During handoff of the mobile node, then, the target network can be capable of locally deriving net_key, such as from the second shared key/key pair, and the second nonce and the unencrypted portion of the assertion token. The target network can then use the locally derived net_key to decrypt the encrypted portion. The encrypted portion, then, can include mn_key such that the mobile node and target network are capable of establishing a trust relationship based upon mn_key, where the mobile node locally derives mn_key, and the target network extracts mn_key from the decrypted portion of the assertion token. In this regard, the mobile node can locally derive mn_key from the first shared key/key pair, and the first nonce, where the mobile node receives the first nonce in a message including the assertion token from the anchor network.

When the generated token information comprises startup token information, the handoff attach message received by the target network processing element(s) includes the startup token information, where the anchor network comprises a home network of the mobile node. The processing element(s) can then facilitate authentication of the mobile node by communicating with the anchor/home network processing element(s) such that the home network processing element(s) are capable of at least partially authenticating the mobile node based upon the handoff attach message. For example, the handoff attach message can be signed with a digital signature based upon a trust relationship between the mobile node and the home network. The home network processing element(s) in such instances can authenticate the mobile node by verifying the digital signature based upon the trust relationship between the mobile node and the home network. Irrespective of how the home network processing element(s) authenticate the mobile node, if the mobile node is authenticated, the home network processing element(s) can thereafter generate and transmit, to the target network processing element(s), an assertion token if the mobile node is authenticated. The target network processing element(s) can then authenticate the mobile node at least partially based upon the assertion token.

According to other aspects of the present invention, a method and computer program product for connecting a mobile node to a target network are provided. Exemplary embodiments of the present invention are therefore capable of proactively delivering a token to the mobile node such that the message sequence required to deliver the token need not occur during connection of the mobile node, either during handoff or powering up. Accordingly, the message sequence required to connect the mobile node is decreased over that required by conventional techniques, such as that provided by the standard mode of operation of the Liberty Alliance Project framework. To effectuate delivery of an assertion token, for example, exemplary embodiments of the present invention can operate based upon a trust relationship between the mobile node and the anchor network, and a trust relationship between the target network and the anchor network. Accordingly, exemplary embodiments of the present invention can effectuate handoff of the mobile node without a pre-existing trust relationship between the mobile node and the target network. As such, the anchor network, target network, method and computer program product of embodiments of the present invention may solve at least some of the problems identified by prior techniques and may provide additional advantages.

### BRIEF DESCRIPTION OF THE DRAWINGS

Having thus described the invention in general terms, reference will now be made to the accompanying drawings, which are not necessarily drawn to scale, and wherein:

FIG. 1 is a block diagram of one type of mobile node and system that would benefit from embodiments of the present invention;

FIG. 2 is a schematic block diagram of a network entity capable of operating as a mobile node, home agent, foreign agent and/or correspondent node, in accordance with embodiments of the present invention;

FIG. 3 is a schematic block diagram of a mobile node, in accordance with one embodiment of the present invention;

FIG. 4 illustrates a multi-layer protocol stack of a node in accordance with one embodiment of the present invention where the protocol stack comprises the OSI model including seven layers;

FIG. 5 illustrates a comparison of the OSI functionality of a node in accordance with an embodiment of the present invention, and the generic OSI model;

FIG. 6 is a control flow diagram illustrating communication between various entities performing a method of connecting a mobile node to a target network, such as during handoff of the mobile node from a current, anchor network to the target network, in accordance with one exemplary embodiment of the present invention;

FIGS. 7a, 7b and 7c are functional block diagrams illustrating derivation of cryptographic keys mn_key, net_key and mnidp_key, in accordance with exemplary embodiments of the present invention;

FIG. 8 is a schematic block diagram of a handoff attach message in accordance with one exemplary embodiment of the present invention; and

FIG. 9 is a control flow diagram illustrating communication between various entities performing a method of connecting a mobile node to a target network, such as during powering up the mobile node, in accordance with another exemplary embodiment of the present invention.

### DETAILED DESCRIPTION OF THE INVENTION

The present invention now will be described more fully hereinafter with reference to the accompanying drawings, in which exemplary embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

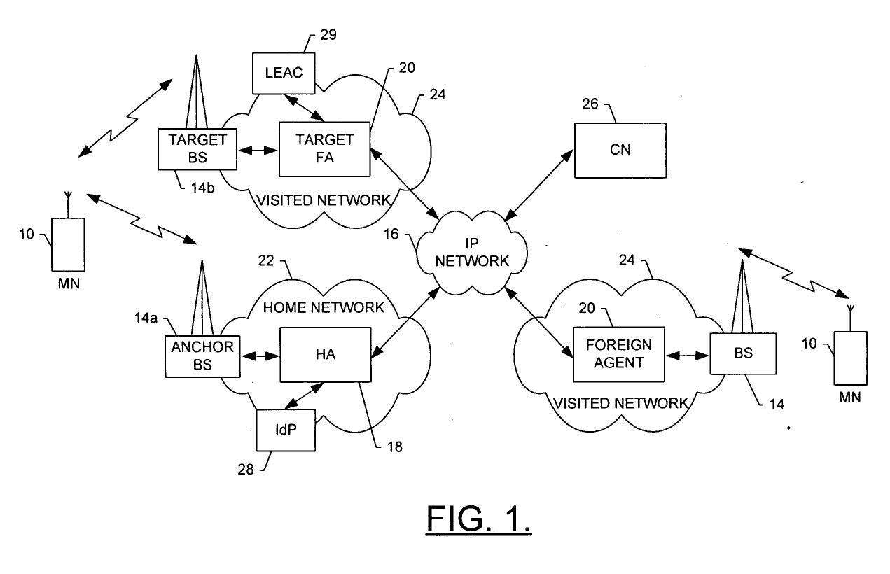

Referring to FIG. 1, an illustration of one type of system that would benefit from exemplary embodiments of the present invention is provided. The system, method and computer program product of exemplary embodiments of the present invention will be primarily described in conjunction with mobile communications applications. It should be understood, however, that the system, method and computer program product of exemplary embodiments of the present invention can be utilized in conjunction with a variety of other applications, both in the mobile communications industries and outside of the mobile communications industries. For example, the system, method and computer program product of exemplary embodiments of the present invention can be utilized in conjunction with wireline and/or wireless network (e.g., Internet) applications.

As shown, the system can include a mobile node (MN) 10 capable of transmitting signals to and for receiving signals from base sites or base stations (BS) 14 (one or more of which may be more particularly referred to as access points—AP's), two of which are shown in FIG. 1. As shown and described below, the base stations include an anchor BS 14a that provides access to a home network during handoff, and a target BS 14b that provides access to a foreign network during handoff. One or more base stations are part of one or more cellular or mobile networks that each include elements required to operate the network, such as a mobile switching center (MSC) (not shown). As well known to those skilled in the art, the mobile network may also be referred to as a Base Station/MSC/Interworking function (BMI). In operation, the MSC is capable of routing calls to and from the terminal when the terminal is making and receiving calls. The MSC can also provide a connection to landline trunks when the terminal is involved in a call. In addition, the MSC can be capable of controlling the forwarding of messages to and from the terminal, and can also control the forwarding of messages for the terminal to and from a messaging center.

The MN 10 can also be coupled to a data network. For example, one or more base stations 14 can be coupled to one or more data networks, such as a local area network (LAN), a metropolitan area network (MAN), and/or a wide area network (WAN). In one typical embodiment, the BS is coupled to a gateway, router or the like, which is coupled to the data network, such as an Internet Protocol (IP) network 16. The gateway can comprise any of a number of different entities capable of providing network connectivity between the MN and other nodes directly or indirectly coupled to the data network. As will be appreciated, the gateway can be described in any of a number of different manners, such as a home agent (HA) 18, foreign agent (FA) 20 (shown and described below as including a target FA during handoff), packet data serving node (PDSN), access router (AR) or the like. In this regard, as defined in the MIP (MIP) protocol, a HA comprises a router within a home network 22 of the MN. The HA is capable of tunneling data for delivery to the MN when the MN is away from home, and can maintain current location information for the MN. A FA, on the other hand, may comprise a router within a visited network 24 of the MN. The FA provides routing services to the MN while the MN is registered with the visited network. In operation, the FA detunnels data from the HA, and delivers the data to the MN. Then, for data sent from a MN registered with the visited network, the FA can serve as a default router. Although exemplary embodiments of the present invention may be described with reference to a MIP protocol, such as MIPv4 or MIPv6, it should be understood that exemplary embodiments of the present invention may operate in accordance with any of a number of other protocols.

The other nodes coupled to the MN 10 via the IP network 16 can comprise any of a number of different devices, systems or the like capable of communicating with the MN in accordance with exemplary embodiments of the present invention. The other nodes can comprise, for example, personal computers, server computers or the like. Additionally or alternatively, for example, one or more other nodes can comprise, other MN's, such as mobile telephones, portable digital assistants (PDA's), pagers, laptop computers, or the like. As described herein, a node capable of communicating with the MN via the IP network is referred to as a correspondent node (CN) 26, one of which is shown in FIG. 1. As also shown and described, one or more of the networks 22, 24 can include an identity provider (IdP) 28 for maintaining the credentials and authorization profiles for a plurality of MN users (one being shown coupled to the home network). In addition, one or more networks can include an authentication center for authenticating and authorizing MN's to access the respective networks (one being shown coupled to a visited network). As shown, for example, the authentication center may be at least partially configured in accordance with the Liberty Alliance Project framework, and may accordingly be referred to as a Liberty-enabled authentication center (LEAC) 29. It should be understood, however, that the authentication center may be additionally or alternatively configured in accordance with any of a number of other frameworks without departing from the spirit and scope of exemplary embodiments of the present invention. For example, the authentication center may be implemented in a network entity also supporting another authentication center, such as that provided in accordance with the Third Generation Partnership Project (3GPP), where the authentication center and 3GPP authentication center may be logically separate, but co-located, within the network entity.

Although not every element of every possible network is shown and described herein, it should be appreciated that the MN 10 can be coupled to one or more of any of a number of different networks. In this regard, mobile network(s) can be capable of supporting communication in accordance with any one or more of a number of second-generation (2G), 2.5G and/or third-generation (3G) mobile communication protocols or the like. Additionally or alternatively, mobile network(s) can be capable of supporting communication in accordance with any of a number of different wireless networking techniques, including WLAN techniques such as IEEE 802.11, WiMAX techniques such as IEEE 802.16 or the like. Further, for example, the mobile network(s) can be capable of supporting communication in accordance with any one or more of a number of different digital broadcast networks, such as Digital Video Broadcasting (DVB) networks including DVB-T (DVB-Terrestrial) and/or DVB-H (DVB-Handheld), Integrated Services Digital Broadcasting (ISDB) networks including ISDB-T (ISDB-Terrestrial), or the like.

More particularly, for example, the MN 10 can be coupled to one or more networks capable of supporting communication in accordance with 2G wireless communication protocols IS-136 (TDMA), GSM, and IS-95 (CDMA). Also, for example, one or more of the network(s) can be capable of supporting communication in accordance with 2.5G wireless communication protocols GPRS, Enhanced Data GSM Environment (EDGE), or the like. In addition, for example, one or more of the network(s) can be capable of supporting communication in accordance with 3G wireless communication protocols such as cdma2000, Universal Mobile Telephone System (UMTS) network employing Wideband Code Division Multiple Access (WCDMA) radio access technology. Further, one or more of the network(s) can be capable of supporting enhanced 3G wireless communication protocols such as 1XEV-DO (TIA/EIA/IS-856) and 1XEV-DV.

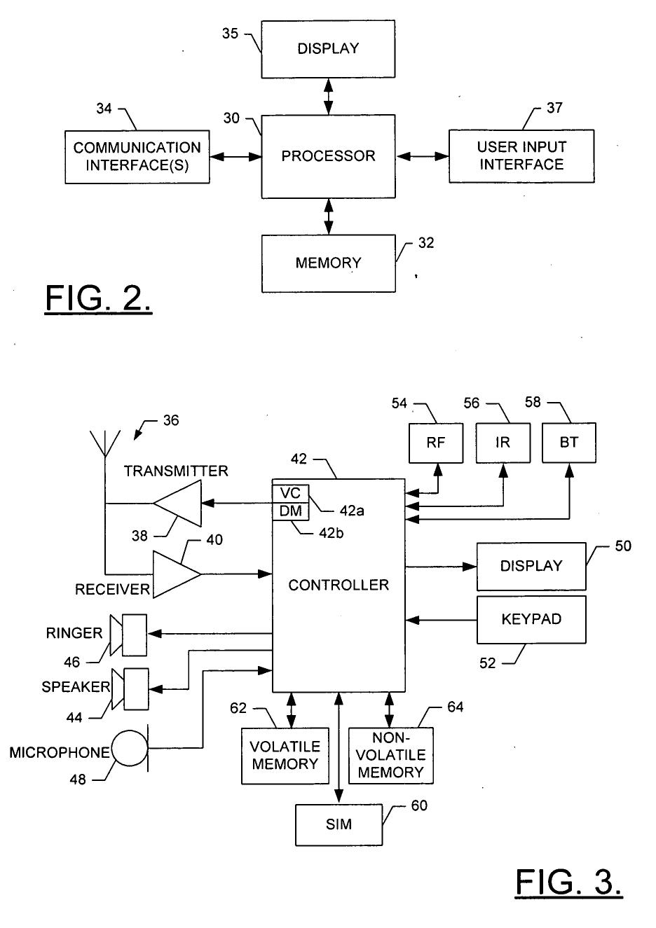

Referring now to FIG. 2, a block diagram of a network entity capable of operating as a MN 10, HA 18, FA 20, CN 26, IdP 28 and/or LEAC 29 is shown in accordance with one embodiment of the present invention. Although shown as separate entities, in some embodiments, one or more entities may support one or more of a MN, HA, FA, CN, IdP and/or LEAC logically separated but co-located within the entit(ies). For example, a single entity may support a logically separate, but co-located, HA and CN. Also, for example, a single entity may support a logically separate, but co-located FA and CN. In addition, for example, a single entity may support a logically separate, but co-located HA, IdP and/or LEAC. Similarly, for example, a single entity may support a logically separate, but co-located FA, IdP and/or LEAC.

The entity capable of operating as a MN 10, HA 18, FA 20, CN 26, IdP 28 and/or LEAC 29 includes various means for performing one or more functions in accordance with exemplary embodiments of the present invention, including those more particularly shown and described herein. It should be understood, however, that one or more of the entities may include alternative means for performing one or more like functions, without departing from the spirit and scope of the present invention. More particularly, for example, as shown in FIG. 2, the entity can include a processor 30 connected to a memory 32. The memory can comprise volatile and/or non-volatile memory, and typically stores content, data or the like. For example, the memory typically stores content transmitted from, and/or received by, the entity. Also for example, the memory typically stores client applications, instructions or the like for the processor to perform steps associated with operation of the entity in accordance with embodiments of the present invention. As explained below, for example, the memory can store client application(s).

As described herein, the client application(s) each comprise software operated by the respective entities. It should be understood, however, that any one or more of the client applications described herein can alternatively comprise firmware or hardware, without departing from the spirit and scope of the present invention. Generally, then, the MN 10, HA 18, FA 20, CN 26, IdP 28 and/or LEAC 29 can include one or more logic elements for performing various functions of one or more client application(s). As will be appreciated, the logic elements can be embodied in any of a number of different manners. In this regard, the logic elements performing the functions of one or more client applications can be embodied in an integrated circuit assembly including one or more integrated circuits integral or otherwise in communication with a respective network entity (i.e., MN, HA, FA, CN, IdP, LEAC, etc.) or more particularly, for example, a processor 30 of the respective network entity. The design of integrated circuits is by and large a highly automated process. In this regard, complex and powerful software tools are available for converting a logic level design into a semiconductor circuit design ready to be etched and formed on a semiconductor substrate. These software tools, such as those provided by Avant! Corporation of Fremont, Calif. and Cadence Design, of San Jose, Calif., automatically route conductors and locate components on a semiconductor chip using well established rules of design as well as huge libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

In addition to the memory 32, the processor 30 can also be connected to at least one interface or other means for displaying, transmitting and/or receiving data, content or the like. In this regard, the interface(s) can include at least one communication interface 34 or other means for transmitting and/or receiving data, content or the like. As explained below, for example, the communication interface(s) can include a first communication interface for connecting to a first network, and a second communication interface for connecting to a second network. In addition to the communication interface(s), the interface(s) can also include at least one user interface that can include a display 35 and/or a user input interface 37. The user input interface, in turn, can comprise any of a number of devices allowing the entity to receive data from a user, such as a keypad, a touch display, a joystick or other input device.

Reference is now made to FIG. 3, which illustrates one type of MN 10 that would benefit from exemplary embodiments of the present invention. It should be understood, however, that the MN illustrated and hereinafter described is merely illustrative of one type of MN that would benefit from the present invention and, therefore, should not be taken to limit the scope of the present invention. While several exemplary embodiments of the MN are illustrated and will be hereinafter described for purposes of example, other types of MN's, such as portable digital assistants (PDA's), pagers, laptop computers and other types of electronic systems, can readily employ the present invention.

The MN 10 includes various means for performing one or more functions in accordance with exemplary embodiments of the present invention, including those more particularly shown and described herein. It should be understood, however, that the MN may include alternative means for performing one or more like functions, without departing from the spirit and scope of the present invention. More particularly, for example, as shown in FIG. 3, in addition to an antenna 36, the MN 10 can include a transmitter 38, receiver 40, and controller 42 or other processor that provides signals to and receives signals from the transmitter and receiver, respectively. These signals include signaling information in accordance with the air interface standard of the applicable cellular system, and also user speech and/or user generated data. In this regard, the MN can be capable of operating with one or more air interface standards, communication protocols, modulation types, and access types. More particularly, the MN can be capable of operating in accordance with any of a number of second generation (2G), 2.5G and/or third-generation (3G) communication protocols or the like. For example, the MN may be capable of operating in accordance with 2G wireless communication protocols IS-136 (TDMA), GSM and IS-95 (CDMA), 2.5G wireless communication protocols such as GPRS and/or Enhanced Data GSM Environment (EDGE), and/or 3G wireless communication protocols such as cdma2000, Universal Mobile Telephone System (UMTS) network employing Wideband Code Division Multiple Access (WCDMA) radio access technology. Also, for example, the MN can also be capable of operating in accordance with enhanced 3G wireless communication protocols such as 1XEV-DO (TIA/EIA/IS-856) and 1XEV-DV. Further, for example, the MN can be capable of operating in accordance with any of a number of different wireless networking techniques, including WLAN techniques such as IEEE 802.11, WiMAX techniques such as IEEE 802.16 or the like.

It is understood that the controller 42 includes the circuitry required for implementing the audio and logic functions of the MN 10. For example, the controller may be comprised of a digital signal processor device, a microprocessor device, and various analog-to-digital converters, digital-to-analog converters, and other support circuits. The control and signal processing functions of the MN are allocated between these devices according to their respective capabilities. The controller can additionally include an internal voice coder (VC) 42a, and may include an internal data modem (DM) 42b. Further, the controller may include the functionality to operate one or more software programs, which may be stored in memory (described below). For example, the controller may be capable of operating a connectivity program, such as a conventional Web browser. The connectivity program may then allow the MN to transmit and receive Web content, such as according to HTTP and/or the Wireless Application Protocol (WAP), for example.

The MN 10 may also comprise a user interface including a conventional earphone or speaker 44, a ringer 46, a microphone 48, a display 50, and a user input interface, all of which are coupled to the controller 42. The user input interface, which allows the MN to receive data, can comprise any of a number of devices allowing the MN to receive data, such as a keypad 52, a touch display (not shown) or other input device. In embodiments including a keypad, the keypad includes the conventional numeric (0-9) and related keys (#, *), and other keys used for operating the MN. Although not shown, the MN can include a battery, such as a vibrating battery pack, for powering the various circuits that are required to operate the MN, as well as optionally providing mechanical vibration as a detectable output.

The MN 10 can also include one or more means for sharing and/or obtaining data. For example, the MN can include a short-range radio frequency (RF) transceiver 54 so that data can be shared with and/or obtained from electronic devices in accordance with RF techniques. In this regard, the RF transceiver may function as a WLAN and/or WAN interface capable of sharing data with other radio frequency transceivers in accordance with WLAN and/or WAN techniques. The MN can additionally, or alternatively, include other short-range transceivers, such as, for example an infrared (IR) transceiver 56, and/or a Bluetooth (BT) transceiver 58 operating using Bluetooth brand wireless technology developed by the Bluetooth Special Interest Group. The MN can therefore additionally or alternatively be capable of transmitting data to and/or receiving data from electronic devices in accordance with such techniques.

The MN 10 can further include memory, such as a subscriber identity module (SIM) 60, a removable user identity module (R-UIM) or the like, which typically stores information elements related to a mobile subscriber. In addition to the SIM, the MN can include other removable and/or fixed memory. In this regard, the MN can include volatile memory 62, such as volatile Random Access Memory (RAM) including a cache area for the temporary storage of data. The MN can also include other non-volatile memory 64, which can be embedded and/or may be removable. The non-volatile memory can additionally or alternatively comprise an EEPROM, flash memory or the like. The memories can store any of a number of software applications, instructions, pieces of information, and data, used by the MN to implement the functions of the MN. For example, the memories can store an identifier, such as an international mobile equipment identification (IMEI) code, international mobile subscriber identification (IMSI) code, mobile station integrated services digital network (MSISDN) code (mobile telephone number), Internet Protocol (IP) address, Session Initiation Protocol (SIP) address or the like, capable of uniquely identifying the MN.

As explained in the background section, a typical handoff (e.g., IP handoff) of the mobile terminal requires link-layer and network-layer (e.g., IP-layer) signaling. When a mobile terminal is handed off from one network to another network, the mobile terminal is typically authenticated and authorized at the link layer as well as the network layer. During movement of the mobile node from one network to another, however, there should be minimal disruption to an application (at the application layer) running on the mobile node. Unfortunately, a disruption may arise due to increased procedure steps, response latency, packet loss, and the like, during such a handoff. More particularly, frameworks such as the standard operation of the single-sign-on (SSO) framework provided by the Liberty Alliance Project, are reactive frameworks that specify a high number of messages across an air interface. Such a high number of messages, then, increase the likelihood of disruption at the application layer during handoff.

As explained in greater detail below, exemplary embodiments of the present invention therefore provide a framework for effectuating connecting a MN 10 to a target network. More particularly, exemplary embodiments of the present invention provide a framework for effectuating handoff from one, anchor point of connection to another, target point of connection in various networks the MN visits along its route. Further, exemplary embodiments of the present invention provide a framework for effectuating connection to a target point of connection during powering up the MN. Embodiments of the present invention are connecting a MN to a point of connection, whether during handoff or powering up, while reducing the message exchange between entities to authenticate and authorize the MN at the network layer (e.g., IP layer). In accordance with the framework of exemplary embodiments of the present invention, the MN is capable of receiving information from which the MN user can be authenticated and authorized to access a target network, before communication between the MN and the target network is initiated during handoff. More particularly in comparison to the conventional Liberty Alliance Project framework, in accordance with the framework of exemplary embodiments of the present invention, the MN is capable of receiving a token, such as an assertion token or startup token, without first contacting the target network to request access thereto. The token can then be used to authenticate and authorize the MN user to the target network.

The framework of exemplary embodiments of the present invention is capable of effectuating connection to a target network without a pre-existing trust relationship between the MN 10 and the target network, with the MN and anchor network, and the anchor network and the target network typically having a trust relationship. In this regard, a number of the cryptographic keys used for security purposes during handoff can be derived at or before the time of the actual handoff. Further, when the anchor and target networks are members of a federation within which the members have a trust relationship, the target network need not be identified before or at the time of generating the assertion token. In this regard, the assertion token can be generically generated based upon the trust relationship between members of the federation.

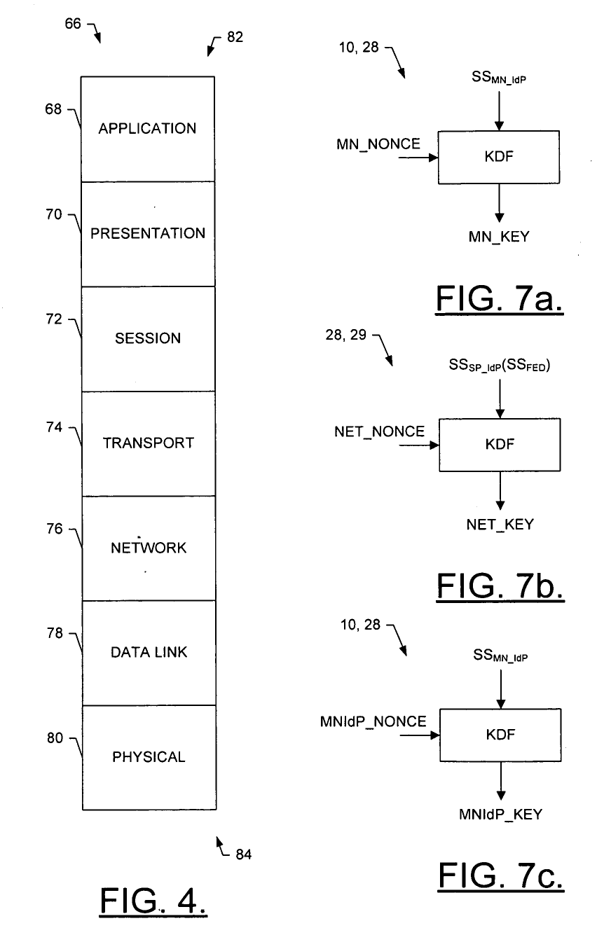

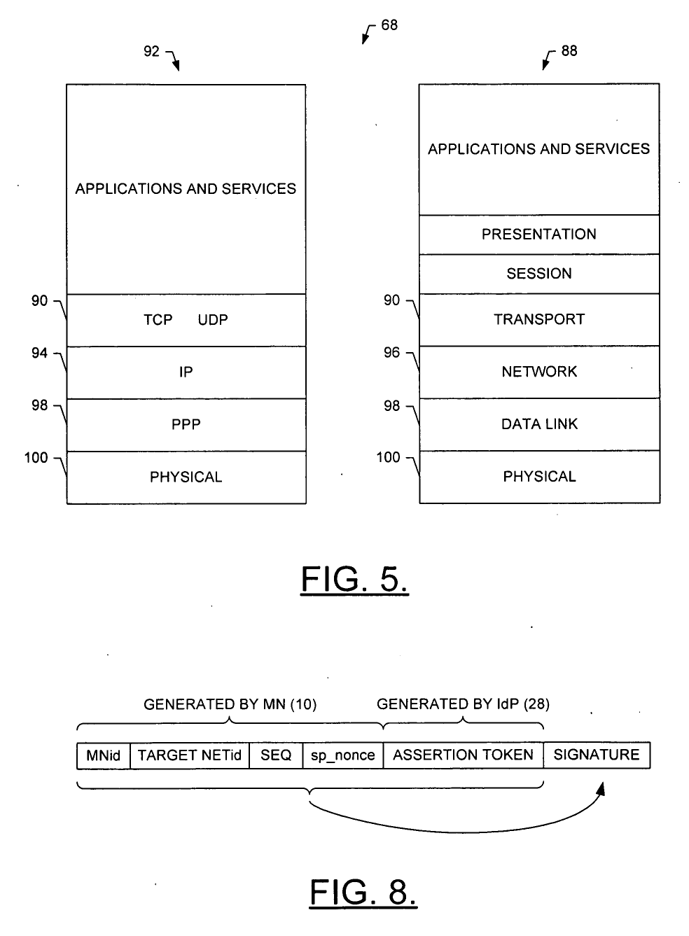

Before describing the method of effectuating connection, either during handoff or powering up, in accordance with various exemplary embodiments of the present invention, reference is made to FIGS. 4 and 5 which illustrate a protocol stack of a node (e.g., MN 10, CN 26, etc.) and a comparison of the protocol stack of the node in accordance with embodiments of the present invention, and the generic Open Systems Interconnection (OSI) model. In FIGS. 4 and 5, the protocol stack may be implemented in software, hardware, firmware or combinations of the same. More particularly, FIG. 4 illustrates the OSI model 66 which includes seven layers, including an application layer 68, presentation layer 70, session layer 72, transport layer 74, network layer 76, data link layer 78 and physical layer 80. The OSI model was developed by the International Organization for Standardization (ISO) and is described in ISO 7498, entitled: The OSI Reference Model, the contents of which are incorporated herein by reference in its entirety.

Each layer of the OSI model 66 performs a specific data communications task, a service to and for the layer that precedes it (e.g., the network layer 76 provides a service for the transport layer 74). The process can be likened to placing a letter in a series of envelopes before it is sent through the postal system. Each succeeding envelope adds another layer of processing or overhead information necessary to process the transaction. Together, all the envelopes help make sure the letter gets to the right address and that the message received is identical to the message sent. Once the entire package is received at its destination, the envelopes are opened one by one until the letter itself emerges exactly as written.

Actual data flow between two nodes (e.g., MN 10 and CN 26) is from top 82 to bottom 84 in the source node, across the communications line, and then from bottom 84 to top 82 in the destination node. Each time that user application data passes downward from one layer to the next layer in the same node more processing information is added. When that information is removed and processed by the peer layer in the other node, it causes various tasks (error correction, flow control, etc.) to be performed.

The ISO has specifically defined all seven layers, which are summarized below in the order in which the data actually flows as they leave the source node.

Layer 7, the application layer 68, provides for a user application to interface with the OSI application layer. And as indicated above, the OSI application layer can have a corresponding peer layer in another node communicating with the application layer.

Layer 6, the presentation layer 70, makes sure the user information is in a format (i.e., syntax or sequence of ones and zeros) the destination node can understand or interpret.

Layer 5, the session layer 72, provides synchronization control of data between the nodes (i.e., makes sure the bit configurations that pass through layer 5 at the source are the same as those that pass through layer 5 at the destination).

Layer 4, the transport layer 74, ensures that an end-to-end connection has been established between the two nodes and is often reliable (i.e., layer 4 at the destination confirms the request for a connection, so to speak, that it has received from layer 4 at the source node).

Layer 3, the network layer 76, provides routing and relaying of data through the network (among other things, at layer 3 on the outbound side an address gets placed on the envelope which is then read by layer 3 at the destination).

Layer 2, the data link layer 78, includes flow control of data as messages pass down through this layer in one node and up through the peer layer in the other node.

Layer 1, the physical interface layer 80, includes the ways in which data communications equipment is connected mechanically and electrically, and the means by which the data moves across those physical connections from layer 1 at the source node to layer 1 at the destination node.

FIG. 5 illustrates a comparison 86 of the OSI functionality of the MN 10 and/or CN 26 in accordance with embodiments of the present invention, and the generic OSI model. More particularly, FIG. 5 illustrates where the Internet Protocol (IP) network layer 94 fits in the OSI seven layer model 88. As shown, the transport layer 90 provides data connection services to applications and may contain mechanisms that guarantee that data is delivered error-free, without omissions and in sequence. The transport layer in the TCP/IP model 92 sends segments by passing them to the IP layer, which routes them to the destination. The transport layer accepts incoming segments from the IP layer, determines which application is the recipient, and passes the data to that application in the order in which it was sent.

Thus, the IP layer 94 performs network layer 96 functions and routes data between nodes (e.g., MN 10 and CN 26). Data may traverse a single link or may be relayed across several links in an IP network 16. Data is carried in units called datagrams, which include an IP header that contains layer 3 98 addressing information. Routers examine the destination address in the IP header in order to direct datagrams to their destinations. The IP layer is called connectionless because every datagram is routed independently and the IP layer does not guarantee reliable or in-sequence delivery of datagrams. The IP layer routes its traffic without caring which application-to-application interaction a particular datagram belongs to.

The Transmission Control Protocol (TCP) layer 90 provides a reliable data connection between devices using TCP/IP protocols. The TCP layer operates on top of the IP layer 94 that is used for packing the data to data packets, sometimes referred to as datagrams, and for transmitting the datagrams across the data link layer and underlying network via physical layer 100. The data link layer can operate in accordance with any of a number of different protocols, such as the Point-to-Point Protocol (PPP). As will be appreciated, the IP protocol doesn't contain any flow control or retransmission mechanisms. That is why the TCP layer 90 is typically used on top of the IP layer 94. In this regard, TCP protocols provide acknowledgments for detecting lost data packets.

A. Effectuating Handoff

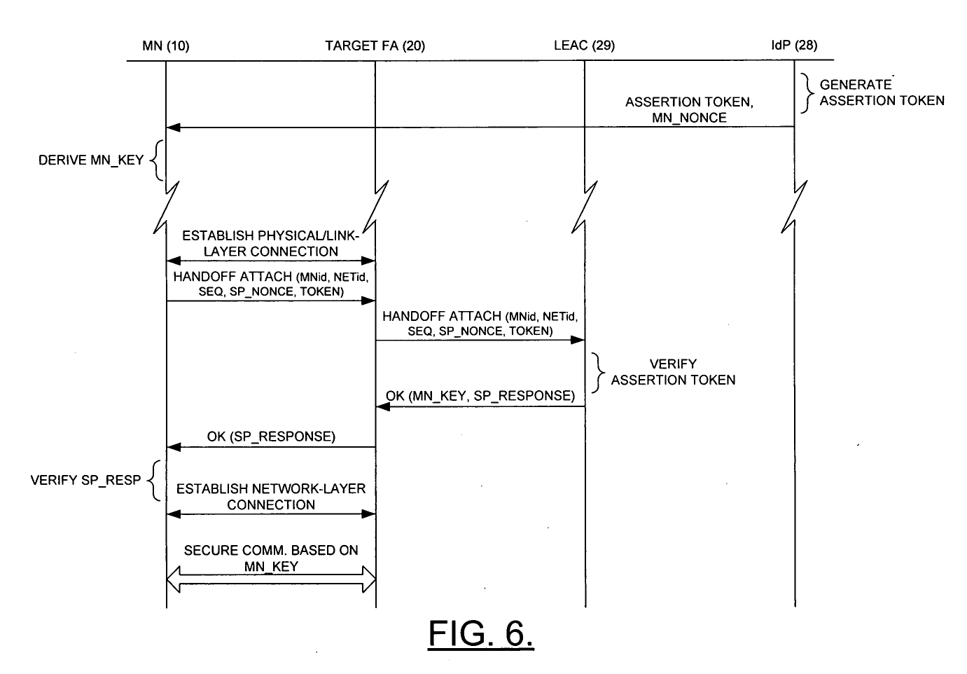

Reference is now made to FIG. 6, which illustrates a control flow diagram of a method of connecting a MN 10 to a target network, such as during handoff the MN 10 from an anchor network to the target network. More particularly, for example, the control flow diagram illustrates a method of handing off a MN from a HA 18 in a home network 22 to a new, target FA 20b in a visited network 24, such as during a communication session between the MN and a CN 26. It should be understood, however, that the MN can be equally handed off from an anchor FA in a visited network to a target FA in another visited network, or alternatively from an anchor FA in a visited network to a target HA in a home network, without departing from the spirit and scope of the present invention. Also, as explained below, the method of FIG. 6 is particularly applicable to handing off a MN from one type of network to another type of network. In this regard, the method of FIG. 6 will be explained in conjunction with handing off a MN from an anchor AR (i.e., anchor FA) in a WLAN network to a target PDSN (i.e., target FA) in a CDMA-based network (e.g., cdma2000 network, WCDMA network, etc.). It should be understood, however, that the method of FIG. 6 can be equally applicable to handing off a MN from any of a number of other types of networks to any of a number of the same or different types of networks, without departing from the spirit and scope of the present invention. For example, the method of FIG. 6 can be equally applicable to handing off a MN from one instance of a WLAN network to another instance of a WLAN network, from a GPRS network to a CDMA-based network, from a CDMA-based network to a GPRS network, or the like.

Further, as explained below, exemplary embodiments of the present invention are particularly applicable for use in systems and methods configured in accordance with the Liberty Alliance Project SSO framework. It should be understood, however, that embodiments of the present invention may be equally applicable in frameworks other than the Liberty Alliance Project SSO framework. Without loss of generality, then, in accordance with exemplary embodiments of the present invention, handoff in accordance with exemplary embodiments of the present invention is effectuated via a message exchange between the MN 10, a current home network 22 and a target visited network 24. In various instances, the MN may be referred to as a user agent, while the visited network to which the MN is handed off may be referred to as a service provider that provides access to its network (i.e., requested service during handoff) from which the user agent can access other services of the same network and/or one or more other networks (e.g., via the IP network 16).

It is generally presumed that a trust relationship exists between the MN 10 and an IdP 28 in the home network 22, where that trust relationship is evidenced by a cryptographic key SSₘₙ_{_{—}}_{idp} shared between the MN and the IdP. Similarly, it is generally presumed that a trust relationship exists between the target visited network 24 and the IdP in the home network, which is similarly evidenced by a cryptographic key SSₛₚ_{_{—}}_{idp} shared between the target visited network and the IdP. It also generally presumed that network entities in networks in the same federation (e.g., networks having a roaming agreement for handoff) have a trust relationship evidenced by a shared cryptographic key SS_{fed}, and that the home network and the target visited network may (but need not) be in the same federation. Further, although a direct trust relationship may exist between the MN and the target visited network, it is generally presumed that no such trust relationship exists.

As shown in FIG. 6, a method of handing off a MN 10 from an anchor HA 18 in a home network 22 to a target FA 20 in a visited network 24 in accordance with one exemplary embodiment of the present invention includes an IdP 28 in the home network 22 generating an assertion token for handoff authentication/authorization of the MN. In this regard, the IdP can be initiated to generate an assertion token in any of a number of different manners, either at its own initiative or in response to a trigger from a network entity (e.g., MN, HA 18, etc.) to generate an assertion token for a given MN. Generally, before the IdP generates the assertion token, however, the IdP has information sufficient to generate the assertion token for the given MN, such as a MN identifier MNid (e.g., MN network address identifier (NAI), etc.). In addition, the IdP generally has information identifying a target visited network 24, or alternatively identifying a federation of networks including the home network. Such information may be already known to the IdP or alternatively be communicated to the IdP in the trigger from the network entity.

Before the IdP 28 generates the assertion token (or before the IdP transmits the assertion token to the MN 10—explained below), the IdP may first authenticate the MN (or MN user) and/or verify that the MN is authorized to access the identified target visited network 24 (or federation of networks). In this regard, the IdP can authenticate the MN in any of a number of different manners including, for example, HTTP digest authentication, transport layer security (TLS) techniques or the like. Similarly, the IdP can verify authorization of the MN in a number of different manners including, for example, based upon an authorization profile associated with the MN, or more particularly the MN user, maintained by the IdP. One technique that may be implemented by the IdP for verifying authorization of the MN is that provided in the Liberty Alliance Project framework.

If the IdP 28 verifies authorization of the MN, the IdP can proceed to generate the assertion token (or transmit a generated assertion token), otherwise the IdP may refuse to generate the assertion token. The IdP can generate the assertion token in any of a number of different manners. In one exemplary embodiment, for example, the IdP generates the assertion token by first selecting two random nonces, referred to as mn_nonce and net_nonce. As shown in FIGS. 7a and 7b, the IdP then executes a pre-defined key derivation function (KDF) to derive two cryptographic keys (or two key pairs), referred to as mn_key and net_key. More particularly, the IdP can derive mn_key from mn_nonce and the cryptographic key shared between the MN and IdP, i.e., SSₘₙ_{_{—}}_{idp}, as shown in FIG. 7a. Similarly, the IdP can derive net_key from net_nonce and the cryptographic key shared between the target visited network 24 (i.e., service provider) and the IdP, i.e., SSₛₚ_{_{—}}_{idp}, provided the IdP has information identifying the target visited network, as shown in FIG. 7b. Alternatively, the IdP can derive net_key from net_nonce and the cryptographic key shared by networks in the same federation, i.e., SS_{fed}. Although the IdP can execute the KDF to derive the respective keys in any appropriate manner, the IdP of one exemplary embodiment derives the respective keys to have sufficient cryptographic separation between mn_key and net_key and the shared cryptographic keys from which mn_key and net_key are derived. As such, even if an unauthorized entity acquires mn_key and/or net_key and the respective nonce(s) from which the respective key(s) are derived, the unauthorized entity cannot deduce the respective shared cryptographic key(s).

As explained below, the MN 10 and target visited network 24 can utilize mn_key to secure communication therebetween, while the IdP 28 can utilize net_key to encrypt at least a portion of the assertion token. It should be noted that, although mn_key and net_key may be shown and described as being used for both signing and authentication, one or both of mn_key and net_key may alternatively comprise, and thus refer to, a pair of keys, where one key is used for signing and authentication (authentication key) while the other key is used for encrypting and decrypting a message (encryption key). In such instances, the nonces that are used to derive these key pairs may also (but need not) comprise, and thus refer to, nonce pairs themselves. For example, mn_nonce may comprise a first nonce_pair for deriving the authentication mn_key, and a second nonce pair for deriving the encryption mn_key.

In another alternative, the target visited network 24 may have a public key certificate that is known to the home network IdP 28. In such an instance, the content otherwise encrypted with the net_key (i.e., a portion of a handoff attach message, explained below) can instead be encrypted using the public key of the target visited network. And in yet another alternative, that content can be encrypted with a symmetric key, which is in turn encrypted with the public key of the target visited network and attached to the content. Generally, then, although various aspects of exemplary embodiments of the present invention may be implemented with symmetric key cryptography, one or more of those aspects may be equally implemented with asymmetric key cryptography, any combination of symmetric and asymmetric key cryptography, or any other similar cryptographic technique. Similarly, one or more aspects implemented with respect to asymmetric key cryptography may alternatively be implemented with symmetric key cryptography, any combination of symmetric and asymmetric key cryptography, or any other similar cryptographic technique.

After deriving mn_key and net_key, the IdP 28 generates an assertion token, such as in an extensible mark-up language (XML) format, that can include an encrypted portion with one or more pieces of content, and/or an unencrypted portion with one or more pieces of content. For example, the assertion token can include an encrypted portion with information relating to the MN 10 (e.g., MNid, etc.), and mn_key, where the encrypted portion can be encrypted using net_key. In addition, for example, the assertion token can include an unencrypted portion with a home network identifier HOME_NETid (e.g., home network NAI, etc.), a timestamp for creation of the assertion token, a token lifetime, an identifier ID of the recipient of the token (e.g., target visited network NETid—VISITED_NETid—if known, or otherwise an identifier of the federation including the home network 22), and/or net_nonce. Further, if so desired, the unencrypted portion (or encrypted portion) can include a listing of one or more services that the MN (or MN user) is authorized to access using the assertion token. As will be appreciated, a number of pieces of information included in the assertion token generated by the IdP in accordance with exemplary embodiments of the present invention may correspond to pieces of information included in a similar assertion token generated in accordance with the Liberty Alliance Project SSO framework. In contrast to the assertion token generated in accordance with Liberty Alliance Project SSO framework, however, the assertion token of exemplary embodiments of the present invention includes mn_key and net_nonce, and if appropriate, a listing of authorized services. As explained below, inclusion of mn_key and net_nonce in the assertion token facilitates establishment of a trust relationship between the MN and the target visited network.

After generating the assertion token, the IdP 28 transmits a message, including the assertion token and mn_nonce (if so desired) to the MN 10. Before transmitting the message, however, the IdP can digitally sign the assertion token with a private key of a public-private key pair, such as in the same manner as that specified by the Liberty Alliance Project SSO framework. Alternatively, the IdP can digitally sign the assertion token with net_key, if so desired. The IdP can then securely transmit the assertion token or the entire message (including the assertion token and mn_nonce) to the MN using the trust relationship therebetween or using some other inherent MN-home network trust relationship. More particularly, for example, the IdP can securely transmit the entire message by encrypting the message using the shared cryptographic key SSₘₙ_{_{—}}_{idp}. After receiving the message from the IdP, the MN can extract mn_nonce and derive mn_key, such as by executing a KDF with mn_nonce and SSₘₙ_{_{—}}_{idp} (shared between the MN and IdP) in the same manner as the IdP derived mn_key as shown in FIG. 7a. The MN can then store the mn_key and assertion token for subsequent use in handing off from the home network 22 to the target visited network 24 (the target visited network typically being either previously identified, or in the same federation as the home network), as explained below. Before storing the mn_key and the assertion token, however, the MN may perform a check of the assertion token to protect against a replay attack. More particularly for example, the MN may check the timestamp for creation of the received assertion token to verify that the timestamp has a time after that of a similar timestamp for a previously received assertion token (for subsequently received assertion tokens).

At some point after storing the mn_key and assertion token, the MN 10 operating in the home network 22 may be triggered to handoff to the target visited network 24. For example, the MN can monitor the signal strength of the home network, and if desired, the target visited network. Then, when the MN recognizes that the signal strength of the home network decreases below a threshold signal strength, or that the signal strength of the target visited network exceeds that of the home network by at least a threshold amount, the MN can be triggered to handoff to the target visited network. Irrespective of how the MN is triggered to handoff, however, the MN can thereafter initiate a handoff to the target visited network, such as in accordance with any of a number of different conventional manners. For example, the MN can initiate a handoff by establishing a physical-layer (i.e., layer 1) connection with the target BS 14b in the target visited network, and then establishing a link-layer (i.e., layer 2) connection with the target FA 20 in the target visited network, where the link-layer connection is established over the physical layer connection.

In establishing the physical/link layer connection with the target visited network, the MN receives a network address (e.g., IP address) with which the MN 10 can establish a network-layer connection with the target visited network 24 over the link layer connection. Then, after the link-layer connection has been established, and MN has received the network address, the MN attempts to establish a network-layer connection with the target visited network over the link-layer connection. Before the target visited network permits the MN to establish the network-layer connection, however, the target visited network typically authenticates the MN (or MN user) and verifies that the MN (or MN user) is authorized to access the target visited network. Thus, before the MN is authenticated and authorized, the target visited network may not permit establishment of the network-layer connection, and accordingly routing of packets to and from the MN via the target visited network.

To authenticate and establish authorization to access the target visited network 24 in accordance with one exemplary embodiment, the MN 10 can generate and transmit a handoff attach message, such as a Liberty Handoff Attach (LHOA) message, to the target FA 20 in the target visited network. The handoff attach message can include one or more pieces of information. For example, as shown in FIG. 8, the handoff attach message can include the MNid, target visited network VISITED_NETid (e.g., NAI, etc.), and assertion token. The handoff attach message can also include a sequence number (SEQ) that may be used by the MN for replay protection against the assertion token. In addition, the handoff attach message can include another nonce, referred to as sp_nonce, randomly selected by the MN as a challenge to the target visited network so as to facilitate network-side authentication.

Before transmitting the handoff attach message, as shown in FIG. 8, the MN 10 can digitally sign the handoff attach message, such as by computing a keyed hash (e.g., hash-based message authentication code (HMAC) using the SHA1 hash function) with the mn_key (or the authentication mn_key when mn_key comprises a key pair). Further, if so desired, one or more pieces of information in the message, such as the MNid, VISITED_NETid, SEQ and/or sp_nonce, may be encrypted using the mn_key.

After receiving the handoff attach message, the target FA 20 in the target visited network 24 routes the handoff attach message to an LEAC 29 in the target visited network, which is responsible for authenticating the MN 10. In this regard, the LEAC can process the handoff attach message to authenticate and verify the authorization of the MN to access the target visited network. More particularly, for example, the LEAC can process the handoff attach message by extracting and verifying that the VISITED_NETid identifies the target visited network, and that the SEQ is unique to the received handoff attach message and has not been included in a previous handoff attach message (indicating a replay attack).

In addition to verifying the VISITED_NETid and SEQ, the LEAC 29 can also extract and process the assertion token in the handoff attach message. To process the assertion token, the LEAC can verify the digital signature of the assertion token as being signed by the IdP 28. The LEAC can also verify that the assertion token has not expired based upon the current time, and the creation timestamp and token lifetime from the assertion token. In addition, the LEAC can decrypt the encrypted portion of the assertion token to process the information included therein. In this regard, as the IdP 28 encrypted the respective portion of the assertion token with net_key, the LEAC can decrypt the encrypted portion by first deriving net_key (which may represent a key pair), such as by executing a KDF with net_nonce and a shared cryptographic key in the same manner as the IdP derived net_key as shown in FIG. 7b. For this the LEAC may use the IdP identity, the federation identity in the token, and/or any other information to identify the proper shared cryptographic key, such as within a local key-store. In this regard, if the identifier ID in the assertion token identifies the target visited network, the shared key with which the LEAC derives net_key can comprise SSₛₚ_{_{—}}_{idp}. Otherwise, if the identifier ID identifies a federation including the home network 22 and the target visited network 24, the shared key with which the LEAC derives net_key can comprise SS_{fed}.

After decrypting the encrypted portion of the assertion token, the LEAC 29 can verify the information relating to the MN 10 (e.g., MNid, etc.) as corresponding to that of the MN being authenticated/authorized. In addition, the LEAC can extract mn_key from the encrypted portion of the assertion token for further processing. In this regard, although the LEAC may be described above as processing portions of the handoff attach message, such as to verify the SEQ, before extracting mn_key, in those instances where portions of the handoff attach message are encrypted using mn_key, the LEAC decrypts the encrypted portion of the assertion token and extracts mn_key before processing those portions. As such, the LEAC can use the extracted mn_key to first decrypt the encrypted portions of the handoff attach message (e.g., SEQ) before processing those portions. In addition to extracting mn_key to decrypt portions of the handoff attach message (if encrypted), however, the LEAC 29 can use mn_key to verify the digital signature of the handoff attach message as being that of the MN 10, such as by using mn_key to compute a keyed hash (e.g., HMAC-SHA1) in the same manner as the MN.

If the LEAC 29 fails to verify one or more of the processed portions of the handoff attach message, such as by failing to verify the VISITED_NETid or SEQ, the LEAC fails to authenticate the MN 10, and can notify the target FA 20 of the authentication failure. The target FA can then prevent the MN from establishing a network-layer connection with the target visited network 24. Otherwise, if the LEAC successfully verifies the processed portions of the message, the MN is authenticated. Before deeming the MN authenticated, however, the LEAC may optionally contact the IdP 28 in the home network 22 to request additional assurance of the authenticity of the MN. Such additional assurance may be particularly useful to prevent a “colluding MN” attack on the target visited network, as explained below.

If the LEAC 29 authenticates the MN 10, the LEAC can generate a response, referred to as sp_response, based upon mn_key and sp_nonce. The response sp_response can be generated in any of a number of different manners, but is typically generated in a manner known to both the LEAC and the MN. In this regard, if so desired, the LEAC may use mn_key to encrypt sp_response. After generating sp_response, the LEAC 29 can notify the target FA 20 of successful authentication of the MN 10, such as by sending an OK message to the target FA. As shown, the OK message can include sp_response as well as mn_key. Alternatively, the LEAC can separately push sp_response and/or mn_key to the target FA.

Irrespective of how the LEAC 29 transmits sp_response and mn_key to the target FA 20, the MN 10 and target FA can thereafter establish a secure network-layer connection therebetween based upon sp_response and mn_key. More particularly, after receiving sp_response and mn_key, the target FA can notify the MN of the successful authentication, such as by sending an OK message to the MN. As shown, the OK message to the MN can include sp_response, although it should be understood that the target FA can separately push sp_response to the MN. Irrespective of how the target FA transmits sp_response to the MN, the MN can thereafter decrypt (if encrypted) and verify sp_response to authenticate the target FA and thus the target visited network 24. For example, the MN can verify sp_response by generating a comparison sp_response based upon mn_key and sp_nonce (maintained by the MN) in the same manner as the LEAC generated the received sp_response, and then identifying a match between the comparison sp_response and the received sp_response.

If the MN 10 fails to verify sp_response, the MN may terminate its physical and link-layer connections with the target visited network 24, or alternatively reattempt to authenticate to the target visited network. On the other hand, if the MN successfully verifies sp_response, the MN can establish a network-layer (e.g., IP-layer) connection to the target visited network over the previously established link-layer connection, the target FA 20 accepting the network-layer connection with the MN having been authenticated. Thereafter, the MN can communicate with the target FA across the network-layer connection, and thus, communicate across the target visited network. Further, if so desired, the MN and target FA can securely communicate by protecting the communications based upon mn_key, known to both the MN and target FA. For example, the MN can initiate a transport layer security—Pre-Shared Key (TLS-PSK) session with the target FA based on mn_key for future communications between the MN and the target network.

B. Effectuating Connection (e.g., During Powering Up, Reconnection, etc.)

As will be appreciated the authorization and authentication framework of exemplary embodiments of the present invention may be utilized in a number of contexts other than handing off a MN 10 from one network (e.g., an anchor HA 18 in a home network 22) to another network (e.g., a target FA 20 in a visited network 24). Generally, for example, exemplary embodiments of the present invention may be utilized to authorize and authenticate the MN to connect to a target network, whether during handoff or otherwise. More particularly, exemplary embodiments of the present invention may be utilized to initially connect to a target network during start up or power up of the MN. In other instances, exemplary embodiments of the present invention may be utilized to reconnect to a target network (home or visited) in instances in which the MN abruptly powers off or otherwise disconnects from the respective network (accidentally or otherwise), such as when the MN disconnects form the respective network without sufficient time to send a handoff assertion token from the IdP 28 to the MN), whether during handoff or otherwise. In the case of powering up in the home network, the MN may more typically be authorized and authenticated in accordance with the framework enforced in the home network. In the case of powering up in a visited network, on the other hand, the framework of exemplary embodiments of the present invention may facilitate connecting to the visited network.

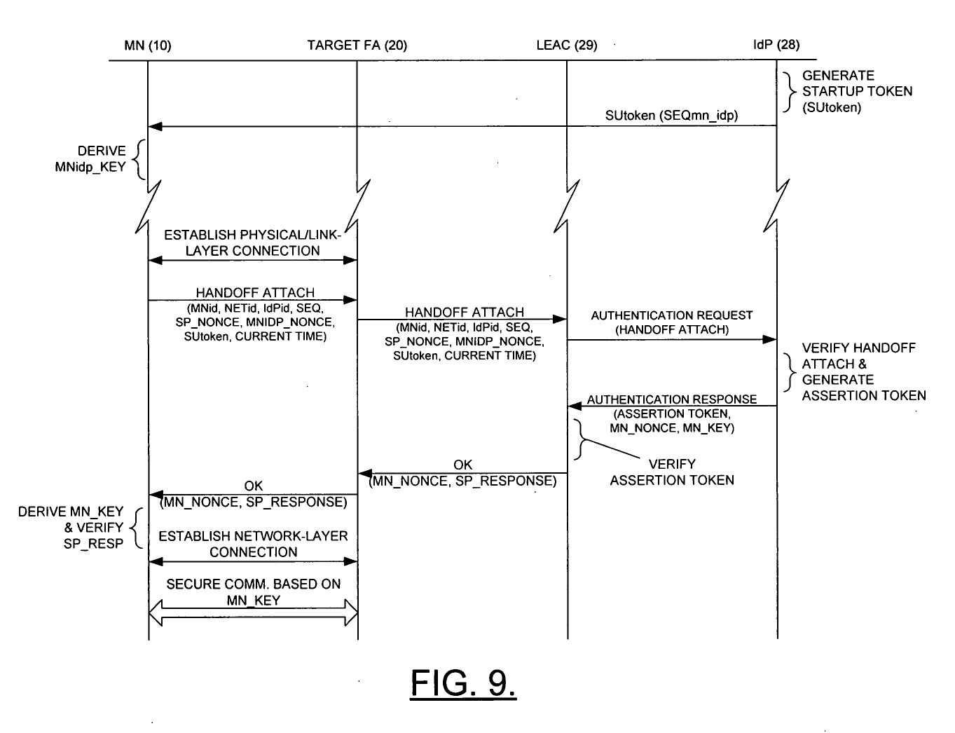

Reference is now made to FIG. 9, which illustrates a control flow diagram of a method of generally connecting a MN 10 to a target network, including a home network 22 or a visited network 24 of the MN, such as during powering up the MN, in accordance with an exemplary embodiment of the present invention. As shown, the exemplary method includes an IdP 28 in the home network 22 generating a startup token (SUtoken) for connection authentication/authorization of the MN. In this regard, the IdP can be initiated to generate a startup token in any of a number of different manners, either at its own initiative or in response to a trigger from a network entity (e.g., MN, HA 18, etc.) to generate a startup token for a given MN. Generally, before the IdP generates the assertion token, however, the IdP has information sufficient to generate the startup token for the given MN, such as a MN identifier MNid (e.g., MN network address identifier (NAI), etc.).

Before the IdP 28 generates the startup token (or before the IdP transmits the startup token to the MN 10—explained below), the IdP may first authenticate the MN (or MN user). In this regard, the IdP can authenticate the MN in any of a number of different manners including, for example, HTTP digest authentication, transport layer security (TLS) techniques or the like. If the IdP successfully authenticates the MN, the IdP can proceed to generate the startup token (or transmit a generated startup token), otherwise the IdP may refuse to generate the startup token. The IdP can generate the startup token in any of a number of different manners. The startup token can include a sequence number (SEQmn_idp) maintained between the MN and IdP that may be used for replay protection against the startup token. Thus, as will be appreciated, the startup token may be refreshed by the IdP each time the MN uses the existing startup token (explained below).

After generating the startup token, the IdP 28 transmits the startup token, including SEQmn_idp, to the MN 10 such that the MN can store the startup token. The IdP can securely transmit the assertion token or the entire message (including the assertion token and mn_nonce) to the MN using the trust relationship therebetween or using some other inherent MN-home network trust relationship. More particularly, for example, the IdP can securely transmit the startup token by encrypting and/or integrity protecting the startup token based on the shared cryptographic key SSₘₙ_{_{—}}_{idp} or some private/public key pair.

At some point after storing the startup token, the MN 10 may be triggered to connect to the target visited network 24, such as by starting up or otherwise powering on the MN. Irrespective of how the MN is triggered to connect to the target visited network, however, the MN can thereafter initiate a connection to the target visited network, such as in accordance with any of a number of different conventional manners. Similar to the case of handing off the MN, for example, the MN can initiate a connection by establishing a physical-layer (i.e., layer 1) connection with the target BS 14b in the target visited network, and then establishing a link-layer (i.e., layer 2) connection with the target FA 20 in the target visited network, where the link-layer connection is established over the physical layer connection.

In establishing the physical/link layer connection with the target visited network, the MN receives a network address (e.g., IP address) with which the MN 10 can establish a network-layer connection with the target visited network 24 over the link layer connection. Then, after the link-layer connection has been established, and MN has received the network address, the MN attempts to establish a network-layer connection with the target visited network over the link-layer connection. Before the target visited network permits the MN to establish the network-layer connection, however, the target visited network typically authenticates the MN (or MN user) and verifies that the MN (or MN user) is authorized to access the target visited network. Thus, before the MN is authenticated and authorized, the target visited network may not permit establishment of the network-layer connection, and accordingly routing of packets to and from the MN via the target visited network.

Similar to the case of handing off the MN 10, to authenticate and establish authorization to access the target visited network 24 in accordance with one exemplary embodiment, the MN can generate and transmit a handoff attach message, such as a LHOA message, to the target FA 20 in the target visited network. At any point after the MN receives the startup token from the IdP 28, but before or as the MN generates and transmits the handoff attach message, the MN can select a random nonce, referred to as mnidp_nonce. As shown in FIG. 7c, the MN then executes a pre-defined KDF to derive a cryptographic key, referred to as mnidp_key, from mnidp_nonce and the cryptographic key shared between the MN and IdP, i.e., SSₘₙ_{_{—}}_{idp}. The MN can thereafter store mnidp_key for subsequent use in connecting to a target visited network, facilitated by including mnidp_nonce in the handoff attach message. Similar to mn_key and/or net_key, mnidp_key may alternatively comprise any of a number of different entities in a number of different cryptographic frameworks. For example, mnidp_key may comprise a pair of keys, where one key is used for signing and authentication (authentication key) while the other key is used for encrypting and decrypting a message (encryption key).

In addition to mnidp_nonce, the handoff attach message can include one or more other pieces of information. Similar to the case of handing off the MN, for example, the handoff attach message can include the MNid, the target visited network VISITED_NETid (e.g., NAI, etc.), a sequence number (SEQ), and sp_nonce, randomly selected by the MN. In addition, in the case of connecting to the target visited network 24 during powering up the MN, the handoff attach message can further include the startup token (including SEQmn_idp) (in lieu of an assertion token), an IdP 28 identifier IdPid (e.g., NAI, etc.), as well as a timestamp for creation of the handoff attach message.

Before transmitting the handoff attach message, the MN 10 can digitally sign the handoff attach message, such as by computing a keyed hash (e.g., hash-based message authentication code (HMAC) using the SHA1 hash function) with the mnidp_key (or the authentication mnidp_key when mnidp_key comprises a key pair). Further, if so desired, one or more pieces of information in the message, such as the MNid, VISITED_NETid, IdPid, SEQ and/or sp_nonce, may be encrypted using the mnidp_key.

After receiving the handoff attach message, the target FA 20 in the target visited network 24 routes the handoff attach message to an LEAC 29 in the target visited network, which is responsible for authenticating the MN 10. In this regard, the LEAC can process the handoff attach message to authenticate and verify the authorization of the MN to access the target visited network. More particularly, for example, the LEAC can process the handoff attach message by extracting and verifying that the VISITED_NETid identifies the target visited network, and that the SEQ is unique to the received handoff attach message and has not been included in a previous handoff attach message (indicating a replay attack).

In addition to verifying the VISITED_NETid and SEQ, the LEAC 29 can also observe that the handoff attach message includes a startup token in lieu of an assertion token, the startup token thereby triggering further action on the part of the LEAC. In response to identifying the startup token in the handoff attach message, then, the LEAC can send an authentication request, including the handoff attach message, to the IdP 28 (identified by the IdPid in the message) for further processing, such as using the trust relationship between the home network 22 and the target visited network 24 (i.e., SSₛₚ_{_{—}}_{idp} or SS_{fed}). To process the handoff attach message, the IdP can verify the digital signature of the handoff attach message as being signed by the MN (having signed the message using mnidp_key). In this regard, the IdP can extract mnidp_nonce from the handoff attach message and derive mnidp_key, such as by executing a KDF with mnidp_nonce and SSₘₙ_{_{—}}_{idp} (shared between the MN and IdP) in the same manner as the MN derived mnidp_key as shown in FIG. 7c. The IdP can then use the derived mnidp_key to verify the digital signature of the handoff attach message.

The IdP 28 can also verify that the startup token in the handoff attach message is not a replay based upon SEQmn_idp (in the startup token) (and handoff attach message timestamp). If the LEAC 29 or IdP fails to verify one or more of the processed portions of the handoff attach message, such as by failing to verify the VISITED_NETid or SEQ, or the digital signature or SEQmn_idp, the LEAC or IdP fails to authenticate the MN 10, and can notify the target FA 20 of the authentication failure. The target FA can then prevent the MN from establishing a network-layer connection with the target visited network 24. Otherwise, if the LEAC and IdP successfully verifies the processed portions of the message, the MN is authenticated.

If the MN 10 is authenticated, the IdP can generate an assertion token for connection authentication/authorization of the MN to the target visited network 24. Before the IdP generates the assertion token (or before the IdP transmits the assertion token to the LEAC 29—explained below), the IdP may first verify that the MN is authorized to access the identified target visited network. In this regard, the IdP can verify authorization of the MN in a number of different manners including, for example, based upon an authorization profile associated with the MN, or more particularly the MN user, maintained by the IdP. One technique that may be implemented by the IdP for verifying authorization of the MN is that provided in the Liberty Alliance Project framework.

If the IdP 28 verifies authorization of the MN, the IdP can proceed to generate the assertion token (or transmit a generated assertion token), otherwise the IdP may refuse to generate the assertion token. The IdP can generate the assertion token in any of a number of different manners. In one exemplary embodiment, for example, the IdP generates the assertion token in a manner similar to that explained above with respect to handing off the MN, including selecting mn_nonce and deriving mn_key from mn_nonce and the cryptographic key shared between the MN and IdP, i.e., SSₘₙ_{_{—}}_{idp}, as shown in FIG. 7a.

After generating the assertion token, the IdP 28 transmits an authentication response message, including the assertion token (including mn_key) and mn_nonce (if so desired) to the LEAC 29. If so desired, the IdP can securely transmit the assertion token or the entire authentication response (including the assertion token and mn_nonce) to the LEAC using the trust relationship therebetween. More particularly, for example, the IdP can securely transmit the entire authentication response by encrypting and/or integrity protecting the message based on the shared cryptographic key SSₛₚ_{_{—}}_{idp} or SS_{fed}. After receiving the message from the IdP, the LEAC can extract the assertion token and process the assertion token, such as in the same manner as before, including extracting and storing mn_nonce and mn_key. More generally, however, the LEAC can process the assertion token to verify that the IdP asserts the identity of the MN.

If the LEAC 29 fails to verify one or more of the processed portions of the assertion token, the LEAC can notify the target FA 20 of the authentication failure and prevent the MN from establishing a network-layer connection with the target visited network 24. Otherwise, if the LEAC successfully verifies the processed portions of assertion token, the LEAC can generate a response, referred to as sp_response, based upon mn_key and sp_nonce. The response sp_response can be generated in any of a number of different manners, such as in the same manner as in the case of handing off the MN. After generating sp_response, the LEAC can notify the target FA of successful authentication of the MN 10, such as by sending an OK message to the target FA. As shown, the OK message can include sp_response as well as mn_nonce and mn_key. Alternatively, the LEAC can separately push sp_response, mn_nonce and/or mn_key to the target FA.

Irrespective of how the LEAC 29 transmits sp_response, mn_nonce and mn_key to the target FA 20, the MN 10 and target FA can thereafter establish a secure network-layer connection therebetween based upon sp_response, mn_nonce and mn_key. More particularly, after receiving sp_response, mn_nonce and mn_key, the target FA can notify the MN of the successful authentication, such as by sending an OK message to the MN. As shown, the OK message to the MN can include sp_response and mn_nonce, although it should be understood that the target FA can separately push sp_response and mn_nonce to the MN. Irrespective of how the target FA transmits sp_response and mn_nonce to the MN, the MN can thereafter extract (and decrypt/verify if encrypted/signed) mn_nonce and derive mn_key, such as by executing a KDF with mn_nonce and SSₘₙ_{_{—}}_{idp} (shared between the MN and IdP) in the same manner as the IdP derived mn_key as shown in FIG. 7a. The MN can then decrypt (if encrypted) and verify sp_response to authenticate the target FA and thus the target visited network 24, such as in the same manner as before.

Similar to before, if the MN 10 fails to verify sp_response, the MN may terminate its physical and link-layer connections with the target visited network 24, or alternatively reattempt to authenticate to the target visited network. On the other hand, if the MN successfully verifies sp_response, the MN can establish a network-layer (e.g., IP-layer) connection to the target visited network over the previously established link-layer connection, the target FA 20 accepting the network-layer connection with the MN having been authenticated. Thereafter, the MN can communicate with the target FA across the network-layer connection, and thus, communicate across the target visited network. Further, if so desired, the MN and target FA can securely communicate by protecting the communications based upon mn_key, known to both the MN and target FA. For example, the MN can initiate a TLS-PSK session with the target FA based on mn_key for future communications between the MN and the target network.

As will be appreciated, implementing an authentication and authorization technique such as that described above, a number of security considerations arise. For example, transmission of an assertion token from the IdP 28 to the MN 10 may be vulnerable to malicious devices eavesdropping on or tampering with the assertion token (such eavesdropping and/or tampering generally occurring during an attack by a malicious device). In accordance with exemplary embodiments of the present invention, however, the IdP securely transmits the assertion token to the MN based upon a trust relationship between the IdP and MN (evidenced by shared key SSₘₙ_{_{—}}_{idp}), thereby reducing the likelihood of a malicious device successfully attacking the assertion token.

In various instances the MN 10 may transmit the handoff attach message to the target FA 20 via an unsecured channel, which may leave the handoff attach message vulnerable to attack. Even in such instances, however, the handoff attach message may be digitally signed by the MN (see FIG. 8), such as with a private key of a public-private key pair (or using mn_key), thereby reducing the likelihood of a successful attack. Further reducing the likelihood of a successful attack, a portion of the assertion token may be encrypted with a key net_key that has been derived from a cryptographic key shared between the target visited network 24 and the IdP 28 (either directly via SSₛₚ_{_{—}}_{idp} or indirectly by being members of the same federation via SS_{fed}). Thus, although a malicious device may successfully acquire the handoff attach message via the unsecured channel, the malicious device cannot replay the handoff attach message in any other network (or any other federation in the case of deriving net_key from SS_{fed}), as the other network will typically not know the shared key (SSₛₚ_{_{—}}_{idp} or SS_{fed}) used to derive net_key, which may be necessary to decrypt a portion of the handoff attach message. Further, even presuming that the other network is in the same federation, and thus does know the shared key SS_{fed}, the other network's NETid will not match the target visited network VISITED_NETid in the handoff attach message. And when the VISITED_NETid is signed (e.g., with mn_key), the malicious device cannot change the VISITED_NETid in the handoff attach message to that of the other network since mn_key is typically unknown to and unobtainable by the malicious device.

In addition, due to a relatively short token lifetime and the use of the SEQ, a malicious device also cannot replay the assertion token at a later time in the same target visited network 24 (or federation). Even in instances whereby the MN 10 powers off or otherwise disconnects from the home network 22 (accidentally or otherwise) after sending the handoff attach message, a malicious device still cannot typically replay the handoff attach message in the same network although the lifetime may not have expired since the SEQ will indicate that the handoff attach message is a replay of an earlier message. The MN can also be configured to send at least the first message to the target network after being authenticated using a secure connection based on mn_key, thereby further reducing the likelihood of a successful attack.

Further, in small number of instances an authorized, but malicious, MN 10 (MN1) may collude with unauthorized MN's (MN2, etc.) when a federation-shared key SS_{fed} is used to derive net_key, which in turn is used to encrypt a portion of the assertion token (e.g., MNid, mn_key, etc.). This includes instances whereby the MN user is malicious, and instances whereby the MN user is innocent but the MN is compromised and operates in a malicious manner without the user's knowledge. In such instances, the MN1 passes its identity MN1id as well as its mn_key to MN2 so that MN1 and MN2 may access different networks in the same federation. Checks being placed in the authentication framework, with the NETid's as well as the lifetime of the assertion token, reduce the likelihood of a successful attack in such a manner. To further reduce the likelihood of a successful attack, however, the home network IdP 28 may be further required to activate an assertion token before the LEAC 29 can process the assertion token. In such instances, the LEAC may be further required to notify the IdP whenever an assertion token (protected using a federation-shared key) is received for handoff, and thereby request that the IdP activate the token. In response to the request, the IdP can verify that only one assertion token for the MN is active at any given time. If the LEAC requests activation of an otherwise inactive token, the IdP activates the token. On the other hand, if the LEAC requests activation of an already active token, indicating an attempt to access more than one network with the same assertion token, the IdP can deny the request to activate the token. Further, if so desired, the IdP may also notify the LEAC that previously requested activation of the active token that the respective MN may, in fact, be unauthorized.

As explained above, the assertion token can be securely transmitted from the home network IdP 28 to the MN 10, which then forwards the assertion token to the target visited network 24 in the handoff attach message. If the target visited network is identified when the IdP generates the assertion token, the home IdP may alternatively securely transmit the assertion token to the LEAC 29 of the target visited network, with the MN being notified of the token's transmission, if so desired. Then, when the MN transmits a handoff attach message as described above, the handoff attach message does not include the assertion token. The same steps may then be carried out at the LEAC in the target visited network, with the exception that the LEAC received the assertion token prior to the handoff attach message. By transmitting the assertion token from the IdP to the LEAC, exemplary embodiments of the present invention may be effectuated with less information (the assertion token) transmitted to/from the MN over-the-air. In addition, the LEAC of the target visited network may be configurable to perform one or more processing steps prior to receipt of the handoff attach message, thereby speeding up the authentication process at the time of handoff.

As will be appreciated, exemplary embodiments of the present invention may be implemented within the Liberty Alliance Project framework. In such instances, it may be desirable to implement exemplary embodiments of the present invention without materially altering elements within the Liberty Alliance Project framework, such as the target FA 20 in the target visited network to which the MN 10 is handed off. Thus, if so desired, the system of exemplary embodiments of the present invention may further include a proxy server (not shown) in the target visited network, where the proxy server is capable of communicating with the LEAC to effectuate authentication of the MN. Thus, when an existing FA receives a handoff attach message, the FA can be configured to automatically forward that message to the proxy server, which then communicates with the LEAC to effectuate authentication of the MN. Thereafter, the proxy server (or LEAC) can notify the FA as to successful or failed authentication of the MN. In one exemplary implementation, the handoff attach message is transmitted in accordance with the hypertext transfer protocol (HTTP), and the proxy server comprises an HTTP proxy server. The HTTP proxy server then forwards the attach message to the LEAC when it notices that the message has been sent by an MN that has not been authenticated.

As indicated above, although exemplary embodiments of the present invention are shown and described with respect to handing off the MN 10 from the home network 22 to a target visited network 24, exemplary embodiments of the present invention are equally applicable to handing off the MN from a visited network to the home network, or from one visited network to another visited network. In such instances where the anchor network is a visited network, an IdP in the respective visited network can generate an assertion token as described above based at least in part upon information in the assertion token received from the MN when the MN originally connected to the visited network. Alternatively, the FA or IdP in the respective visited network, or the MN, may request that the home network IdP generate an assertion token for delivery to the MN via the visited network. In another alternative, the MN may contact the home network IdP to receive an assertion token for use in the second visited network.

As explained above, exemplary embodiments of the present invention provide a framework for authenticating and authorizing a MN 10 to establish a network-layer (e.g., IP-layer) connection with a target network (home or visited). It should be understood, however, that the framework of exemplary embodiments of the present invention may additionally or alternatively be utilized for authenticating and/or authorizing the MN to establish a connection at other layers, including the link layer. For example, the MN can be configured for authentication/authorization to establish a link-layer connection based upon a first token (assertion or startup), and configured for authentication/authorization to establish a network-layer connection based upon a second token. Alternatively, for example, the MN can be configured for authentication/authorization to establish both the link-layer and network-layer connections based upon the same respective token (assertion or startup). Further, in yet another alternative, network-layer connection can be treated as a service, with appropriate information being carried in a listing of authorized services in the token.

As also explained above, the IdP 28 generates and transmits a token to the MN 10 for use in connecting to a target network, where the token may comprise an assertion token or a startup token. It should be understood, however, that one or both of the tokens may be generated and transmitted in a number of alternative manners. For example, in lieu of generating and transmitting the token to the MN, IdP may alternatively generate and transmit a reference (similar to a token artifact in the Liberty Alliance Project framework) to a respective token to the MN, where the reference may be refreshed after each use by the MN or after the lifetime of the token expires. Alternatively, for example, the MN may itself locally generate a startup token, or a reference to a startup token. Also, for example, in lieu of a startup token including bits of data, the MN may locally generate a “null” startup token or otherwise maintain an empty placeholder where the MN otherwise stores or places a startup token, such as in a handoff attach message. Further, for example, the first instance of powering up the MN (no token has ever been created), the MN may receive or otherwise generate a universal startup token (or universal “null” token). Alternatively, the MN may receive boot-up tokens as part of the key distribution process. Generally, then, the MN may be considered to receive “token information,” such as “assertion token information” or “startup token information,” either transmitted from the IdP or locally generated. Assertion token information, in turn, can comprise an assertion token or assertion token reference. Similarly, startup token information can comprise a startup or “null” token, or a startup token reference.

In instances whereby the MN 10 receives or otherwise generates a reference to a token (assertion or startup), or generates a “null” token, the MN may include the respective reference or “null” token in the handoff attach message to the LEAC 29 in the target network (home network 22 or visited network 24). In this regard, the reference or “null” token can be included in the handoff attach message in place of the respective token. That is, an assertion token reference can be included in a handoff attach message in lieu of an assertion token. Similarly, a startup token reference or “null” token can be included in lieu of a startup token in a handoff attach message. Further, in such instances, the handoff attach message can include the IdPid of an IdP 28, such as the home network IdP, in much the same manner as in the case of using the startup token to connect to a target network explained above with reference to FIG. 9.

Upon receiving a handoff attach message including a token reference or “null” token, the LEAC 29 may be configured to respond in much the same manner as when the LEAC receives a handoff attach message including a startup token, as explained above. In this regard, the LEAC may verify at least a portion of the handoff attach message, and being triggered by the token reference or “null” token, send an authentication request to the IdP 28 (identified by the IdPid in the message). The IdP can then process the authentication request, and if the MN 10 is authenticated, generate an appropriate assertion token. In instances in which the handoff attach message included an assertion token reference previously received by the MN from the IdP, however, the IdP may have also generated the assertion token at the time of generating and transmitting the assertion token reference, where the reference identifies the respective token. Thus, instead of generating an assertion token in response to the authentication request from the LEAC, the IdP may alternative retrieve a previously generated assertion token based upon the respective token reference. Irrespective of when the assertion token is generated, however, after the authentication request is processed and the assertion token is generated, the method may continue as in the case of using a startup token, with the IdP transmitting the generated assertion token to the LEAC such that the network-layer connection (and/or link-layer or other layer connection) can be established between the MN and the LEAC based upon the generated assertion token.

According to one exemplary aspect of the present invention, the functions performed by one or more of the entities of the system, such as the MN 10, HA 18, FA 20, IdP 28 and/or LEAC 29, may be performed by various means, such as hardware and/or firmware, including those described above, alone and/or under control of a computer program product. The computer program product for performing one or more functions of embodiments of the present invention includes a computer-readable storage medium, such as the non-volatile storage medium, and software including computer-readable program code portions, such as a series of computer instructions, embodied in the computer-readable storage medium.

In this regard, FIGS. 6 and 9 are control flow diagrams of systems, methods and program products according to exemplary embodiments of the present invention. It will be understood that each block or step of the control flow diagrams, and combinations of blocks in the control flow diagrams, can be implemented by various means, such as hardware, firmware, and/or software including one or more computer program instructions. As will be appreciated, any such computer program instructions may be loaded onto a computer or other programmable apparatus (i.e., hardware) to produce a machine, such that the instructions which execute on the computer or other programmable apparatus create means for implementing the functions specified in the control flow diagrams block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the control flow diagrams block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the control flow diagrams block(s) or step(s).

Accordingly, blocks or steps of the control flow diagrams support combinations of means for performing the specified functions, combinations of steps for performing the specified functions and program instruction means for performing the specified functions. It will also be understood that one or more blocks or steps of the control flow diagrams, and combinations of blocks or steps in the control flow diagrams, can be implemented by special purpose hardware-based computer systems which perform the specified functions or steps, or combinations of special purpose hardware and computer instructions.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A target network for receiving a mobile node, the target network comprising at least one network entity, the at least one network entity comprising:
at least one processing element capable of establishing a link-layer connection with the mobile node over a previously established physical-layer connection,
wherein the at least one processing element is capable of receiving a handoff attach message from the mobile node, the handoff attach message including token information, the token information having been received by the mobile node before establishment of the physical-layer connection,
wherein the at least one processing element is capable of at least one of authenticating, or facilitating authentication of, the mobile node based upon the handoff attach message, and
wherein the at least one processing element is capable of establishing a network-layer connection with the mobile node over the link-layer connection if the mobile node is authenticated.

2. A target network according to claim 1, wherein the target network is adapted to receive the mobile node from an anchor network during handoff of the mobile node, and
wherein the token information in the handoff attach message received by the at least one processing element comprises assertion token information having been received by the mobile node after verifying authorization of the mobile node to access the target network, and before establishment of the physical-layer connection.

3. A target network according to claim 2, wherein the handoff attach message received by the at least one processing element includes assertion token information having been generated based upon a trust relationship between the mobile node and the anchor network, and a trust relationship between the target network and the anchor network.

4. A target network according to claim 2, wherein the target network and the anchor network are members of a federation, and wherein the handoff attach message received by the at least one processing element includes assertion token information having been generated based upon a trust relationship between the mobile node and the anchor network, and a trust relationship between members of the federation.

5. A target network according to claim 2, wherein the handoff attach message received by the at least one processing element includes assertion token information having been generated based upon a trust relationship between the mobile node and the anchor network evidenced by one of a first shared key or key pairs, and a trust relationship between the target network and the anchor network evidenced by one of a second shared key or key pairs, and having been generated according to a process including:
selecting a first nonce and a second nonce;
deriving a key, mn_key, from the first nonce and the one of the first shared key or key pairs;
deriving a key, net_key, from the second nonce and the one of the second shared key or key pairs;
generating assertion token information comprising an assertion token having a portion encrypted with net_key, the encrypted portion of the assertion token including mn_key,
wherein the at least one processing element is capable of authenticating the mobile node including locally deriving net_key at the target network, using locally derived net_key to decrypt the encrypted portion, and extracting mn_key from the decrypted portion of the assertion token, and
wherein the at least one processing element is further capable of securely communicating with the mobile node over the network-layer connection based upon mn_key, the mobile node having locally derived mn_key.

6. A target network according to claim 1, wherein the token information in the handoff attach message received by the at least one processing element comprises startup token information,
wherein the at least one processing element is capable of facilitating authentication of the mobile node by communicating with at least one network entity in a home network of the mobile node such that the at least one home network entity is capable of at least partially authenticating the mobile node based upon the handoff attach message, and such that the at least one home network entity is capable of generating and transmitting, to the at least one processing element, an assertion token if the mobile node is authenticated, and
wherein the at least one processing element is capable authenticating the mobile node at least partially based upon the assertion token.

7. A target network according to claim 6, wherein the handoff attach message received by the at least one processing element comprises a handoff attach message signed with a digital signature based upon a trust relationship between the mobile node and the home network, and
wherein the at least one processing element is capable of facilitating authentication of the mobile node by communicating the handoff attach message to the at least one home network entity such that the at least one home network entity is capable of verifying the digital signature based upon the trust relationship between the mobile node and the home network.

8. An anchor network for facilitating connecting a mobile node to a target network, the anchor network comprising at least one network entity, the at least one network entity comprising:
at least one processing element capable of generating token information, and transmitting the token to the mobile node such that the mobile node is thereafter capable of using the token information to at least one of authenticate, or facilitate authentication of, the mobile node to the target network during connection of the mobile node to the target network, and
wherein the at least one processing element is capable of generating and transmitting the token information before connection of the mobile node is effectuated, connection of the mobile node including establishing physical-layer, link-layer and network-layer connections with the target network.

9. An anchor network according to claim 8, wherein the anchor network is adapted to facilitate connecting a mobile node to a target network during handoff of the mobile node from the anchor network to the target network,
wherein the token information generated by the at least one processing element comprises assertion token information, the at least one processing element being capable of generating the assertion token information based upon a trust relationship between the mobile node and the anchor network, and a trust relationship between the target network and the anchor network, and
wherein the at least one processing element is capable of transmitting the assertion token information to the mobile node such that the mobile node is thereafter capable of using the assertion token information to authenticate to the target network during handoff of the mobile node from the anchor network to the target network.

10. An anchor network according to claim 9, wherein the at least one processing element is further capable of verifying authorization of the mobile node to access the target network before generating the assertion token information, and
wherein the at least one processing element is capable of generating an assertion token information when authorization of the mobile node is verified, and otherwise refusing to generate the assertion token information.

11. An anchor network according to claim 9, wherein the target network and the anchor network are members of a federation, and wherein the at least one processing element is capable of generating assertion token information based upon a trust relationship between members of the federation.

12. An anchor network according to claim 9, wherein the trust relationship between the mobile node and the anchor network is evidenced by one of a first shared key or key pairs, and the trust relationship between the target network and the anchor network is evidenced by one of a second shared key or key pairs, and wherein the at least one processing element is capable of generating the assertion token information according to a process including:
selecting a first nonce and a second nonce;
deriving a key, mn_key, from the first nonce and the one of the first shared key or key pairs;
deriving a key, net_key, from the second nonce and the one of the second shared key or key pairs; and
generating assertion token information comprising an assertion token having a portion encrypted with net_key such that, during handoff of the mobile node, the target network is capable of locally deriving net_key and using locally derived net_key to decrypt the encrypted portion, and
wherein the encrypted portion includes mn_key such that the mobile node and target network are capable of establishing a trust relationship based upon mn_key, the mobile node locally deriving mn_key, and the target network extracting mn_key from the decrypted portion of the assertion token.

13. An anchor network according to claim 8, wherein the anchor network comprises a home network of the mobile node,
wherein the token information generated by the at least one processing element comprises startup token information,
wherein the at least one processing element capable of transmitting the startup token information to the mobile node such that the mobile node is thereafter capable of transmitting a handoff attach message to at least one network entity in the target network, the handoff attach message including the startup token information,
wherein the at least one processing element is further capable of communicating with the at least one target network entity in response to the at least one target network entity receiving the handoff attach message, the at least one processing element communicating with the at least one target network entity to at least partially authenticate the mobile node, and
wherein the at least one processing element is capable of generating and transmitting, to the at least one target network entity, an assertion token if the mobile node is authenticated such that the at least one target network entity is thereafter capable of authenticating the mobile node to the target network based upon the assertion token during connection of the mobile node to the target network.

14. An anchor network according to claim 13, wherein the handoff attach message received by the at least one target network entity comprises a handoff attach message signed with a digital signature based upon a trust relationship between the mobile node and the anchor network, and
wherein the at least one processing element is capable of authenticating the mobile node by verifying the digital signature based upon the trust relationship between the mobile node and the anchor network.

15. A method of connecting a mobile node to a target network, the method comprising:
establishing a link-layer connection with the mobile node over a previously established physical-layer connection;
receiving a handoff attach message from the mobile node, the handoff attach message including token information, the token having been received by the mobile node before establishment of the physical-layer connection;
at least one of authenticating, or facilitating authentication of, the mobile node based upon the handoff attach message; and if the mobile node is authenticated,
establishing a network-layer connection with the mobile node over the established link-layer connection,
wherein the establishing, receiving and authenticating steps occur at at least one target network entity.

16. A method according to claim 15 adapted for handing off the mobile node from an anchor network to the target network,
wherein receiving a handoff attach message comprises receiving a handoff attach message including token information comprising assertion token information, the assertion token information having been generated after verifying authorization of the mobile node to access the target network, and before establishment of the physical-layer connection.

17. A method according to claim 16, wherein receiving a handoff attach message comprises receiving a handoff attach message including assertion token information having been generated based upon a trust relationship between the mobile node and the anchor network, and a trust relationship between the target network and the anchor network.

18. A method according to claim 16, wherein the target network and the anchor network are members of a federation, and wherein receiving a handoff attach message comprises receiving a handoff attach message including assertion token information having been generated based upon a trust relationship between the mobile node and the anchor network, and a trust relationship between members of the federation.

19. A method according to claim 16, wherein receiving a handoff attach message comprises receiving a handoff attach message including assertion token information having been generated based upon a trust relationship between the mobile node and the anchor network evidenced by one of a first shared key or key pairs, and a trust relationship between the target network and the anchor network evidenced by one of a second shared key or key pairs, and having been generated according to a process including:
selecting a first nonce and a second nonce;
deriving a key, mn_key, from the first nonce and the one of the first shared key or key pairs;
deriving a key, net_key, from the second nonce and the one of the second shared key or key pairs;
generating assertion token information comprising an assertion token having a portion encrypted with net_key, the encrypted portion of the assertion token including mn_key,
wherein the authenticating step includes locally deriving net_key at the at least one target network entity, using locally derived net_key to decrypt the encrypted portion, and extracting mn_key from the decrypted portion of the assertion token, and
wherein the method further comprises securely communicating with the mobile node at the at least one target network entity over the network-layer connection based upon mn_key, the mobile node having locally derived mn_key.

20. A method according to claim 15, wherein receiving a handoff attach message comprises receiving a handoff attach message including token information comprising startup token information,
wherein facilitating authentication of the mobile node comprises communicating with at least one network entity in a home network of the mobile node such that the at least one home network entity is capable of at least partially authenticating the mobile node based upon the handoff attach message, and such that the at least one home network entity is capable of generating and transmitting an assertion token if the mobile node is authenticated, and
wherein authenticating the mobile node comprises receiving the assertion token and authenticating the mobile node at least partially based upon the assertion token.

21. A method according to claim 20, wherein receiving a handoff attach message comprises receiving a handoff attach message signed with a digital signature based upon a trust relationship between the mobile node and the home network, and
wherein facilitating authentication of the mobile node comprises communicating the handoff attach message to the at least one home network entity such that the at least one home network entity is capable of verifying the digital signature based upon the trust relationship between the mobile node and the home network.

22. A method of facilitating connecting a mobile node to a target network, the method comprising:
generating token information; and
transmitting the token information to the mobile node such that the mobile node is thereafter capable of using the token information to at least one of authenticate, or facilitate authentication of, the mobile node to the target network during connection of the mobile node to the target network,
wherein the generating and transmitting steps occur at at least one anchor network entity before connection of the mobile node is effectuated, connection of the mobile node including establishing physical-layer, link-layer and network-layer connections with the target network.

23. A method according to claim 22 adapted to facilitate handing off the mobile node from an anchor network to the target network,
wherein generating token information comprises generating assertion token information, the assertion token information being generated based upon a trust relationship between the mobile node and the anchor network, and a trust relationship between the target network and the anchor network, and
wherein transmitting the token information comprises transmitting the assertion token information to the mobile node such that the mobile node is thereafter capable of using the assertion token information to authenticate to the target network during handoff of the mobile node from the anchor network to the target network.

24. A method according to claim 23 further comprising:
verifying authorization of the mobile node to access the target network before generating the assertion token information,
wherein the generating step comprises generating assertion token information when authorization of the mobile node is verified, and otherwise refusing to generate the assertion token information.

25. A method according to claim 23, wherein the target network and the anchor network are members of a federation, and wherein the generating step comprises generating assertion token information based upon a trust relationship between members of the federation.

26. A method according to claim 23, wherein the trust relationship between the mobile node and the anchor network is evidenced by one of a first shared key or key pairs, and the trust relationship between the target network and the anchor network is evidenced by one of a second shared key or key pairs, and wherein the generating step comprises:
selecting a first nonce and a second nonce;
deriving a key, mn_key, from the first nonce and the one of the first shared key or key pairs;
deriving a key, net_key, from the second nonce and the one of the second shared key or key pairs; and
generating assertion token information comprising an assertion token having a portion encrypted with net_key such that, during handoff of the mobile node, at least one target network entity is capable of locally deriving net_key and using locally derived net_key to decrypt the encrypted portion, and
wherein the encrypted portion includes mn_key such that the mobile node and the at least one target network entity are capable of establishing a trust relationship based upon mn_key, the mobile node locally deriving mn_key, and the at least one target network entity extracting mn_key from the decrypted portion of the assertion token.

27. A method according to claim 22, wherein the anchor network comprising a home network of the mobile node,
wherein generating token information comprises generating startup token information,
wherein transmitting the token information comprises transmitting the startup token information to the mobile node such that the mobile node is thereafter capable of transmitting a handoff attach message to at least one network entity in the target network, the handoff attach message including the startup token information, and wherein the method further comprises:
communicating with the at least one target network entity in response to the at least one target network entity receiving the handoff attach message, communicating with the at least one target network entity including at least partially authenticating the mobile node; and
generating and transmitting, to the at least one target network entity, an assertion token if the mobile node is authenticated such that the at least one target network entity is thereafter capable of authenticating the mobile node to the target network based upon the assertion token during connection of the mobile node to the target network.

28. A method according to claim 27, wherein the handoff attach message transmitted to the at least one target network entity comprises a handoff attach message signed with a digital signature based upon a trust relationship between the mobile node and the anchor network, and
wherein communicating with the at least one target network entity includes receiving the handoff attach message and verifying the digital signature based upon the trust relationship between the mobile node and the anchor network.

29. A computer program product for connecting a mobile node to a target network, the computer program product comprising at least one computer-readable storage medium of at least one target network entity, the at least one computer-readable storage medium having computer-readable program code portions stored therein, the computer-readable program code portions comprising:
a first executable portion for establishing a link-layer connection with the mobile node over a previously established physical-layer connection;
a second executable portion for receiving a handoff attach message from the mobile node, the handoff attach message including token information, the token information having been received by the mobile node before establishment of the physical-layer connection;
a third executable portion for at least one of authenticating, or facilitating authentication of, the mobile node based upon the handoff attach message; and
a fourth executable portion for establishing a network-layer connection with the mobile node over the established link-layer connection when the mobile node is authenticated.

30. A computer program product according to claim 29 adapted for handing off the mobile node from an anchor network to the target network,
wherein the second executable portion is adapted to receive a handoff attach message including token information comprising assertion token information, the assertion token information having been generated after verifying authorization of the mobile node to access the target network, and before establishment of the physical-layer connection.

31. A computer program product according to claim 30, wherein the second executable portion is adapted to receive a handoff attach message including assertion token information having been generated based upon a trust relationship between the mobile node and the anchor network, and a trust relationship between the target network and the anchor network.

32. A computer program product according to claim 30, wherein the target network and the anchor network are members of a federation, and wherein the second executable portion is adapted to receive a handoff attach message including assertion token information having been generated based upon a trust relationship between the mobile node and the anchor network, and a trust relationship between members of the federation.

33. A computer program product according to claim 30, wherein the second executable portion is adapted to receive a handoff attach message including assertion token information having been generated based upon a trust relationship between the mobile node and the anchor network evidenced by one of a first shared key or key pairs, and a trust relationship between the target network and the anchor network evidenced by one of a second shared key or key pairs, and having been generated according to a process including:
selecting a first nonce and a second nonce;
deriving a key, mn_key, from the first nonce and the one of the first shared key or key pairs;
deriving a key, net_key, from the second nonce and the one of the second shared key or key pairs;
generating assertion token information comprising an assertion token having a portion encrypted with net_key, the encrypted portion of the assertion token including mn_key,
wherein the third executable portion is adapted to authenticate the mobile node including locally deriving net_key at the at least one target network entity, using locally derived net_key to decrypt the encrypted portion, and extracting mn_key from the decrypted portion of the assertion token, and
wherein the computer program product further comprises a fifth executable portion for securely communicating with the mobile node at the at least one target network entity over the network-layer connection based upon mn_key, the mobile node having locally derived mn_key.

34. A computer program product according to claim 29, wherein the second executable portion is adapted to receive a handoff attach message including token information comprising startup token information,
wherein the third executable portion is adapted to facilitate authentication of the mobile node by communicating with at least one network entity in a home network of the mobile node such that the at least one home network entity is capable of at least partially authenticating the mobile node based upon the handoff attach message, and such that the at least one home network entity is capable of generating and transmitting an assertion token if the mobile node is authenticated, and
wherein the third executable portion is adapted to authenticate the mobile node by receiving the assertion token and authenticating the mobile node at least partially based upon the assertion token.

35. A computer program product according to claim 34, wherein the second executable portion is adapted to receive a handoff attach message signed with a digital signature based upon a trust relationship between the mobile node and the home network, and
wherein the third executable portion is adapted to facilitate authentication of the mobile node by communicating the handoff attach message to the at least one home network entity such that the at least one home network entity is capable of verifying the digital signature based upon the trust relationship between the mobile node and the home network.

36. A computer program product for facilitating connecting a mobile node to a target network, the computer program product comprising at least one computer-readable storage medium of at least one anchor network entity, the at least one computer-readable storage medium having computer-readable program code portions stored therein, the computer-readable program code portions comprising:
a first executable portion for generating token information; and
a second executable portion for transmitting the token information to the mobile node such that the mobile node is thereafter capable of using the token information to authenticate to the target network during connection of the mobile node to the target network,
wherein the first and second executable portions are adapted to generate and transmit the token information before connection of the mobile node is effectuated, connection of the mobile node including establishing physical-layer, link-layer and network-layer connections with the target network.

37. A computer program product according to claim 36 adapted to facilitate handing off the mobile node from an anchor network to the target network,
wherein the first executable portion is adapted to generate assertion token information, the assertion token information being generated based upon a trust relationship between the mobile node and the anchor network, and a trust relationship between the target network and the anchor network, and
wherein the second executable portion is adapted to transmit the assertion token information to the mobile node such that the mobile node is thereafter capable of using the assertion token information to authenticate to the target network during handoff of the mobile node from the anchor network to the target network.

38. A computer program product according to claim 37 further comprising:
a third executable portion for verifying authorization of the mobile node to access the target network before generating the assertion token information,
wherein the first executable portion is adapted to generate assertion token information when authorization of the mobile node is verified, and otherwise refusing to generate the assertion token information.

39. A computer program product according to claim 37, wherein the target network and the anchor network are members of a federation, and wherein the first executable portion is adapted to generate assertion token information based upon a trust relationship between members of the federation.

40. A computer program product according to claim 37, wherein the trust relationship between the mobile node and the anchor network is evidenced by one of a first shared key or key pairs, and the trust relationship between the target network and the anchor network is evidenced by one of a second shared key or key pairs, and wherein the first executable portion is adapted to generate the assertion token information according to a process including:
selecting a first nonce and a second nonce;
deriving a key, mn_key, from the first nonce and the one of the first shared key or key pairs;
deriving a key, net_key, from the second nonce and the one of the second shard key or key pairs; and
generating assertion token information comprising an assertion token having a portion encrypted with net_key such that, during handoff of the mobile node, at least one target network entity is capable of locally deriving net_key and using locally derived net_key to decrypt the encrypted portion, and
wherein the encrypted portion includes mn_key such that the mobile node and the at least one target network entity are capable of establishing a trust relationship based upon mn_key, the mobile node locally deriving mn_key, and the at least one target network entity extracting mn_key from the decrypted portion of the assertion token.

41. A computer program product according to claim 36, wherein the anchor network comprising a home network of the mobile node,
wherein the first executable portion is adapted to generate startup token information,
wherein the second executable portion is adapted to transmit the startup token information to the mobile node such that the mobile node is thereafter capable of transmitting a handoff attach message to at least one network entity in the target network, the handoff attach message including the startup token information, and wherein the computer program product further comprises:
a third executable portion for communicating with the at least one target network entity in response to the at least one target network entity receiving the handoff attach message, communicating with the at least one target network entity including at least partially authenticating the mobile node; and
a fourth executable portion for generating and transmitting, to the at least one target network entity, an assertion token if the mobile node is authenticated such that the at least one target network entity is thereafter capable of authenticating the mobile node to the target network based upon the assertion token during connection of the mobile node to the target network.

42. A computer program product according to claim 41, wherein the handoff attach message transmitted to the at least one target network entity comprises a handoff attach message signed with a digital signature based upon a trust relationship between the mobile node and the anchor network, and
wherein the third executable portion is adapted to communicate with the at least one target network entity including receiving the handoff attach message and verifying the digital signature based upon the trust relationship between the mobile node and the anchor network.
